(19) United States
(12) Patent Application Publication
(10) Pub. No.: US 2004/0148419 A1
(43) Pub. Date: Jul. 29, 2004

(54) Apparatus and method for multi-user entertainment

(76) Inventors: Yancy T. Chen, Campbell, CA (US); Elizabeth B. Diaz, Woodside, CA (US); David R. Smith, Santa Cruz, CA (US); Michael C. Ip, Fremont, CA (US); Peter Lee, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/351,102

(22) Filed: Jan. 23, 2003

(51) Int. Cl. G06F 15/16

(52) U.S. Cl. 709/231

(57) ABSTRACT

In one embodiment of the invention, an apparatus for providing entertainment functions to multiple users, includes: a computer configured to receive audio data, and process the audio data for subsequent transmission as a streaming audio data, the computer configured to provide an entertainment function to a first user; and a variable function device configured to receive the streaming audio data from the computer and output the streaming audio data as an entertainment function for a second user.

### CROSS REFERENCES TO RELATED APPLICATIONS

This is application has common subject matter with copending application having application Ser. No. 10______ (attorney docket no. 100201717-1), filed Feb. 25, 2002, and entitled “VARIABLE-FUNCTION OR MULTI-FUNCTION APPARATUS AND METHODS”.

### TECHNICAL FIELD

Embodiments of the present invention relate generally to computer systems. More particularly, embodiments of the present invention provide an apparatus and method for a multi-user entertainment, particularly employing a variable-function (and/or multi-function) apparatus and method.

### BACKGROUND

Computers (such as personal computers, notebooks, laptops, palmtops, hand-held processing devices, and/or other types of computing devices) typically show notification items and other graphical items in an area of their display screen. Such notification items include, for example, electronic mail arrival notifications, instant messaging notifications, low battery-power warnings, and/or the like. These notifications can often interrupt the images or items being viewed by the computer user. As a result, these notifications can make the viewing experience of the user less pleasant, particularly if the user is viewing, for example, an entertainment-related image or program on the computer screen or if the user does not wish to be distracted while using the computer. The above-mentioned notification items may also clutter the display screen presentation of the computer, and/or may otherwise confuse or cause an inconvenience to the computer user, particularly if, for example, the computer screen has a small viewing surface area.

In addition, some computer users may place the computer underneath their desks or tables in order to increase the available surface area on their desks or tables. As a result, these computer users will not be able to view any notifications that may occur on the out-of-sight computer display screen or on a computer display screen that has been turned off (if there is a display on the PC itself).

In addition, functionalities in current computers continue to increase. As a result, the base systems of current computers are being burdened (and/or are becoming more complex and expensive) due to the increasing functionalities.

Current computers also integrate extra buttons, additional sensitive or fragile components, infrared (I/R) receivers, and/or other components into the computer bezel. The extra buttons and/or sensitive/fragile components typically result in higher support/service requirements and in increased costs of services for a computer device. Additionally, these additional components in the bezel may increase the manufacturing and design costs for a computer device.

For an I/R receiver integrated in the bezel, the I/R signal from the remote control device must be received in the line-of-sight of the I/R receiver. Thus, an I/R receiver integrated in or attached to the bezel will not be able to receive the I/R signals from a remote control device if, for example, the computer bezel is on the floor or is obstructed by an item on the user's desk.

Therefore, the above-described products typically are limited to particular capabilities and features and suffer from a number of constraints related to high cost, limited functionality, complexity in use, higher service/support requirement, increased manufacturing and design issues, inconvenience for the computer user, and/or other constraints.

### SUMMARY OF EMBODIMENTS OF THE INVENTION

In accordance with an embodiment of the invention, an apparatus capable of interacting with another device includes: a module configured to provide a functionality, where the apparatus is configurable to support a second module for providing an additional functionality in order to permit variable functionality by the apparatus. The functionality may relate to an input-function and/or an output-function.

In another embodiment, an apparatus capable of interacting with another device includes: a module configured to shift a functionality from the other device to the module, where the apparatus is configurable to support a second module for providing an additional functionality in order to expand the functionality of the apparatus.

In another embodiment, a method of manufacturing a variable-function device includes: providing a module configured to provide a functionality, where the variable-function device is configurable to support a second module for providing an additional functionality.

In another embodiment, a method of providing functionality in a variable-function device includes: removing a functionality from a computer that can communicate with the variable-function device; and providing the removed functionality in the variable-function device.

An embodiment of the present invention broadly provides an article of manufacture. In one feature of this embodiment, a machine-readable medium is provided with instructions for: duplicating a function from an entertainment computer, providing the duplicated function in a variable-function device, accessing the function from the entertainment computer, and accessing the duplicated function from the variable-function device. In another feature of this embodiment, a machine-readable medium is provided with instructions for: removing a first function from a function-providing device having a processor, transferring the removed first function to a variable-function device, accessing a second function from the function-producing device, and accessing the removed first function from the variable-function device.

An embodiment of the present invention broadly provides a variable function assembly including a power source, a computer (e.g., an entertainment computer) coupled to the power source, and a variable function device (e.g., a device having a processor) having a generally fixed (or integrated) circuitry. The computer may have a receiver for receiving a function, such as an entertainment function, program, or the like. Before any audio signal or similar signal is transmitted from the computer, the signal may be converted by a computer signal converter in the computer from an analog status to a digital status. Thus, for an analog audio signal, the analog audio signal is converted into a digital audio signal, and the digital audio signal is then transmitted from the entertainment computer to the variable-function device. After the variable-function device has received the digital audio signal, a variable-function signal converter in the variable-function device converts the digital audio signal back into an analog audio signal.

The variable function assembly may also comprise a module coupled to the generally fixed circuitry so that the variable function device may provide a desired function. One or more additional modules may be coupled to the generally fixed circuitry so that the variable function device may provide a plurality of functions. An audio and video generating system (e.g., a television) may be coupled to the computer which includes a processor. An audio volume controller and at least one controller may be coupled to the variable function device for controlling the same. A peripheral device, such as a speaker with digital-to-analog converter, may be coupled to the variable function device, where the speaker can generate audio output signals.

A further embodiment of the present invention provides a method for providing multi-user entertainment comprising providing a variable-function device communicatively coupled to a function-producing device having a processor (e.g., an entertainment computer having a processor), duplicating a function from the function-producing device, and providing the duplicated function in the variable-function device. The method for providing multi-user entertainment additionally comprises accessing the function from the function-producing device and accessing the duplicated function from the variable-function device. Accessing the function on the function-producing device may be simultaneous to accessing of the function on the variable-function device. The duplicated function may comprise a function selected from the group consisting of an input-function, an output function, an entertainment function (e.g., a stream of audio signals, a music play list, a radio program, audio signals from a television program, or any of the like), an information resource function, a security function, a system display function, a system control function, a telephony function, a communication function, a notification function, a productivity function, a transaction function, a value-added service function, a logical window function for a computer, an education function, at least one of audio and visual control function, a device control function, and an advanced functionality function. The method of providing a function additionally comprises connecting the function-producing device to the variable function device through a communication link (e.g., wired path or a wireless path). The variable-function device preferably comprises a module (e.g., a recording module) capable of assisting, permitting, and providing removal and/or duplication of a function from the function-producing device. The function-producing device and the variable-function device may be disposed in separate rooms of a dwelling. The same function (e.g., a unique stream of entertainment flow) may be accessible from both the function-producing device and the variable-function device.

A further embodiment of the present invention provides a method for providing a plurality of functions emanating from a processor-containing device. The method comprises providing a variable-function device and a function-producing device having a processor and communicatively coupled to the variable-function device. The method further comprises removing a first function from the function-producing device, providing the removed first function in the variable-function device, accessing a second function from the function-producing device, and accessing the removed first function from the variable-function device. Both the first function and the second function may be simultaneously, separately displayed. Thus, the accessing of the removed first function and the second function may be simultaneous.

In one embodiment the module has an input stage for receiving an input and an input interface coupled to the input stage for processing the received input. The input interface may comprise a matrix switch. The input stage may comprise an element configured for selecting a desired input and a receiver or transceiver configured to receive the input, which may be generated by a communicative device that is configured to communicate with the variable-function device by wireless or wired communication.

In another embodiment the module comprises an output stage configured to generate output which may be received and processed by an output-receiving device, and an output interface coupled to the output stage and configured to process the output to be generated by the output stage. The output stage may comprise a display screen for displaying a removed function, a transmitter or transceiver configured to transmit the output, and/or an element selected from the group consisting of a light-emitting element, a sound-emitting element, and a motion-actuation element. The module may further comprise one or more of the following: a hub for connecting to at least one peripheral device, a processor, a storage element, and a clock which permits the module to generate an event triggering signal. The function-producing device comprises a microprocessor assembly coupled to a function-producing clock which may be synchronized with the variable-function clock, such as by polling a processor of the function-producing device with a processor of the variable-function device.

A further embodiment of the present invention broadly provides a method for producing a function. The method may comprise providing a variable-function device having a microprocessor assembly including a microprocessor, a generally fixed circuitry, and a remote control receiver. The method further includes coupling a module to the microprocessor assembly (e.g., a computer having a processor) and performing a function with a function-producing device after the remote control receiver receives a signal and subsequently causes a signal to be transmitted to the function-producing device. Preferably, the function-producing device is activated prior to performing the function. The method also comprises removing the function from the function-producing device to produce a removed function, and generating the removed function with the assistance of the module and the microprocessor assembly of the variable-function device. The method for producing a function may further comprise replacing the module with another module coupled to the microprocessor assembly in the variable function device, and generating another function with the assistance of the other module and the microprocessor assembly of the variable function device. Any removed function may be displayed. The signal sent from the variable function device to the function-producing device places the function-producing device in an “on” position. The method for producing a function also may further additionally comprise at least one of the following: recording an entertainment function after sending the signal to function-producing device with the assistance of the remote control receiver, and sending another signal via the remote control receiver at a desired time to cause termination of the recording of the entertainment function which may be stored (e.g., in the memory of the computer, or the like) prior to recording the same.

A further embodiment of the present invention provides a variable function assembly comprising a power source, computer means for producing a desired function, and means, coupled to the computer means, for receiving and producing at least one function from the computer means. The variable function assembly may comprise a module coupled to a generally integrated circuitry so that the means for producing at least one function may provide a function. The computer means may have a receiver means for receiving a function transmitted to the computer means.

Another embodiment of the present invention provides a method of providing a function in a variable-function device comprising: removing a function from a functionality-providing device having a processor and operatively communicating with a variable-function device having a variable-function clock for assisting in allowing operative power to be provided to the functionality-providing device, and providing the removed function in the variable-function device. As indicated, the variable function device may include a generally fixed circuitry to which at least one module is coupled to assist in the removal of any desired function. Any module may be replaced with another module to assist in removing and providing a different function in the variable-function device.

A further embodiment of the invention provides an article of manufacture comprising a machine-readable medium having stored thereon instructions for: activating a processor-containing device at a desired time with the assistance of a remote control receiver of a variable-function device, and providing the removed function in the variable-function device.

Another embodiment of the invention provides a variable function assembly comprising a network, a module, a functionality-providing device having a processor and coupled to the network, and a variable function device coupled to the network and having a generally fixed circuitry coupled to the module, a remote control receiver coupled to the generally fixed circuitry for receiving a signal from a remote control transmitter and assisting in activating the functionality-providing device, and employing a Universal Plug and Play (UPnP) standard to permit the module to generate output relating to a state change of the functionality-providing device. The module may control the functionality-providing device by use of the UPnP standard. The variable-function device may receive operative power (e.g., from standby power) from the functionality-providing device when the latter is in an “off” position.

These provisions together with the various ancillary provisions and features which will become apparent to those skilled in the art as the following description proceeds are attained by the devices, assemblies, and methods of embodiments of the present invention, preferred embodiments thereof being shown with reference to the accompanying drawings, by way of example only, wherein:

### BRIEF DESCRIPTION OF THE DRAWINGS

Embodiments of the present invention are described with reference to the following figures, wherein like reference numerals refer to like parts throughout the various views unless otherwise specified.

FIG. 1 is a block diagram of an apparatus in accordance with an embodiment of the invention.

FIG. 2 is a block diagram of an apparatus in accordance with another embodiment of the invention.

FIG. 3 is a block diagram of an apparatus in accordance with another embodiment of the invention.

FIG. 4 is a block diagram of an apparatus in accordance with another embodiment of the invention.

FIG. 5 is a block diagram of an apparatus in accordance with another embodiment of the invention.

FIG. 6 is a block diagram of an apparatus in accordance with another embodiment of the invention.

FIG. 7 is a block diagram of an apparatus in accordance with another embodiment of the invention.

FIG. 8 is a block diagram of an apparatus in accordance with another embodiment of the invention.

FIG. 9 is a block diagram of an apparatus in accordance with another embodiment of the invention.

FIG. 10 is a block diagram of an apparatus in accordance with another embodiment of the invention.

FIG. 11 is a block diagram of an apparatus in accordance with another embodiment of the invention.

FIG. 12A is a block diagram of an apparatus in accordance with another embodiment of the invention.

FIG. 12B is a block diagram of an apparatus in accordance with another embodiment of the invention.

FIG. 13 is a block diagram of an apparatus in accordance with another embodiment of the invention.

FIG. 14 is a block diagram of an apparatus in accordance with another embodiment of the invention.

FIG. 15 is a block diagram of an apparatus in accordance with another embodiment of the invention.

FIG. 16 is a block diagram of an apparatus in accordance with another embodiment of the invention.

FIG. 17 is a flow diagram of a method in accordance with an embodiment of the invention.

FIG. 18 is a block diagram of an apparatus in accordance with another embodiment of the invention.

FIG. 19 is a schematic block diagram of another embodiment of the invention.

FIG. 20 is a schematic block diagram of a further embodiment of the invention.

FIG. 21 is a schematic block diagram of a playlist, in accordance with an embodiment of the invention.

FIG. 22 is a schematic block diagram of still yet another embodiment of the invention.

FIG. 23 is a schematic block diagram of another embodiment of the invention.

FIG. 24 is a schematic block diagram of yet another embodiment of the invention.

FIG. 25 is a schematic block diagram of yet another embodiment of the invention.

FIG. 26 is a schematic block diagram of yet another embodiment of the invention.

FIG. 27 is a schematic block diagram of yet another embodiment of the invention.

FIG. 28 is a schematic block diagram of yet another embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

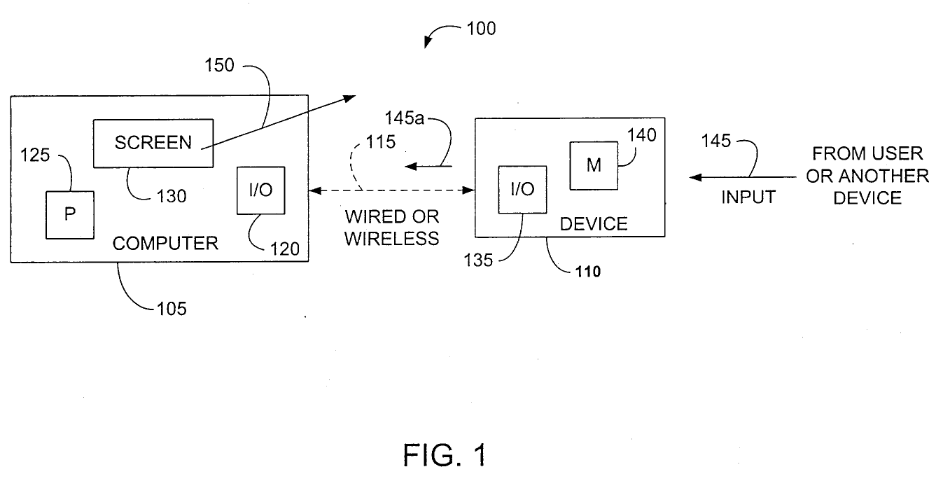

FIG. 1 is a block diagram of a system 100 in accordance with an embodiment of the invention. The system 100 may include a computer 105, and a variable-function device 110 that can communicate with the computer 105 via communication path 115. It is understood that for purposes of explaining functionalities of embodiments of the invention, the elements in the drawings are not necessarily drawn to scale. As described below, the communication links shown in the drawings, such as, for example, the communication path 115 or the path of input 145, may be a wired connection, wireless connection, bus connection, network connection, and/or other types of suitable communication links.

The computer 105 may be, for example, a personal computer, notebook, laptop, palmtop, handheld processing device, and/or another type of computing device. However, as described in another embodiment below, the computer 105 may instead be another type of device, such as, for example, a printer or other peripheral devices. In one embodiment, the computer 105 is a home entertainment computer that is configured to provide home entertainment functions.

Typically, the computer 105 includes an input/output (I/O) interface 120, a processor 125, and a display screen 130. For purposes of describing embodiments of the invention, other known elements in the computer 105 have been omitted in FIG. 1.

In one embodiment of the invention, the variable-function device 110 includes an I/O interface 135 and at least one module 140 for performing at least one particular function (or functionality) as described further below. As also described below in another embodiment, at least an additional module for performing a particular functionality may be added to (or integrated with) the variable-function device 100 in order to permit the variable-function device 110 to provide a variable number of functionalities. The I/O interfaces 120 and 135 are coupled by the communication link 115 so that communication (or interaction) can occur between the computer 105 and the variable-function device 110. The communication link 115 may be a wired or wireless communication path. For example, the communication link 115 may be a cable, a wire(s), a bus connection such as a universal serial bus (USB) or another type of bidirectional bus, and/or other suitable wired or wireless links.

USB is a serial bus for connecting peripherals to a computer, and was developed by Intel Corporation, Santa Clara, Calif. The USB external bus standard supports data transfer rates of, for example, approximately 480 Mbps (480 million bits per second), with possibilities of greater bandwidth in the future. A single USB port can be used to connect up to, for example, about 127 peripheral devices, such as mice, modems, and keyboards. USB also supports Plug-and-Play (PnP) installation, hot plugging, and multiple data streams.

Of course, the communication link 115 may also be a connection in a local area network (LAN), wide area network (WAN), or another type of network where the computer 105 and the variable-function device 110 can communicate with each other via paths in the network.

The communication link 115 may also be a wireless path where, for example, infrared (I/R) or radio frequency (RF) communication can occur between the computer 105 and the variable-function device 110. A suitable wireless protocol, such as, for example, the Bluetooth wireless protocol, the Digital Enhanced Cordless Telecommunications (DECT) technology, or the IEEE 802.11 standards, may be used in the wireless communication process between the computer 105 and the variable-function device 110.

The I/O interfaces 120 and 135 may be, for example, serial ports, parallel ports, universal serial bus (USB) ports or other bus ports, infrared interfaces, radio frequency (RF) interfaces, transceivers, receivers and transmitters, other wired communication interfaces, other wireless communication interfaces, and/or other suitable communication interfaces.

The interface types for the I/O interfaces 120 and 135 will typically depend on the type of communication link 115 between the computer 105 and the variable-function device 110, and/or on the constraints in the computer 105 and the variable-functional device 110.

In one embodiment the variable-function device 110 includes an input-function module 140 that can provide an input-related function (or input-related functionality). Examples of input related functions or functionalities are described in detail below. As also described below, the variable-function device 110 can also include, for example, an output-function module, a combination of at least one input-function module and at least one output-function module, multiple input-function modules, multiple output-function modules, a single input-function module and multiple output-function modules, a single output-function modules and multiple input-function modules, and/or multiple input-function and output-function modules.

The input-function module 140 can receive an input 145 from a user (or from another device). The input 145 may be processed (e.g., encoded or decoded) by the I/O interface 135 for transmission via communication link 115 as signal 145a. The signal 145a is then processed (e.g., decoded or encoded) by the I/O interface 120 in the computer 105. Based upon the signal 145a (which is, in turn, based upon the input 145), the processor 125 in the computer 105 can permit or execute a desired function or feature, such as, for example, switching the computer 105 into an on-state, having the computer 105 send an e-mail in a network, or showing a content or program 150 on the computer screen 130. Thus, an input 145 (e.g., the user pressing one button or other user-actions) may be performed by the user via the variable-function device 110 to permit a desired operation or feature to be performed in the computer 105.

However, it is noted that an input 145 may not necessarily be transmitted via the link 115 to permit a desired event occurrence in the computer 105. For example, the input 145 may be transmitted to another device via another communication path. As another example, the input-function module 140 may be a memory device that can store data as provided by the input 145. This stored data may, for example, be subsequently read by the computer 105 or by any other suitable device that can communicate with the variable-function device 110. As also described below, in response to an input 145, the variable-function device 110 may provide an output function (or output functionality). For example, an input 145 may cause the variable-function device 110 to output a picture image, a photograph, an advertisement, a text message, lighting, music or other audio output, a logo such as an “HP” logo from HEWLETT-PACKARD COMPANY of Palo Alto, Calif., a video, and/or other output functionalities, as described in detail below.

Various known design schemes or methods for integrating a component in a device may be used to integrate or include an input-function module 140 in a variable-function device 110. An example of a suitable design scheme or method may be of the type used for manufacturing the product known as JORNADA from HEWLETT-PACKARD COMPANY.

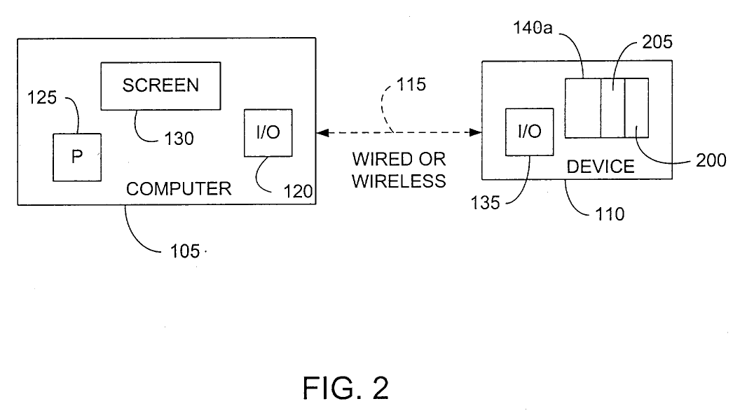

As an example as shown in FIG. 2, the input-function module 140 in FIG. 1 may be a module 140a to permit a user to change a mode in the computer 105. In this specific case, the module 140a may include an input stage 200 that may be, for example, a mode switching button(s) or mode control element(s), a light-detector, a sound-detector (e.g., a microphone), and/or other suitable elements that can accept an input command. The module 140a may further include an input interface 205 for transmitting or processing the input received by input stage 200. The input interface 205 may be, for example, a matrix switch (e.g., a 3-by-5 matrix switch).

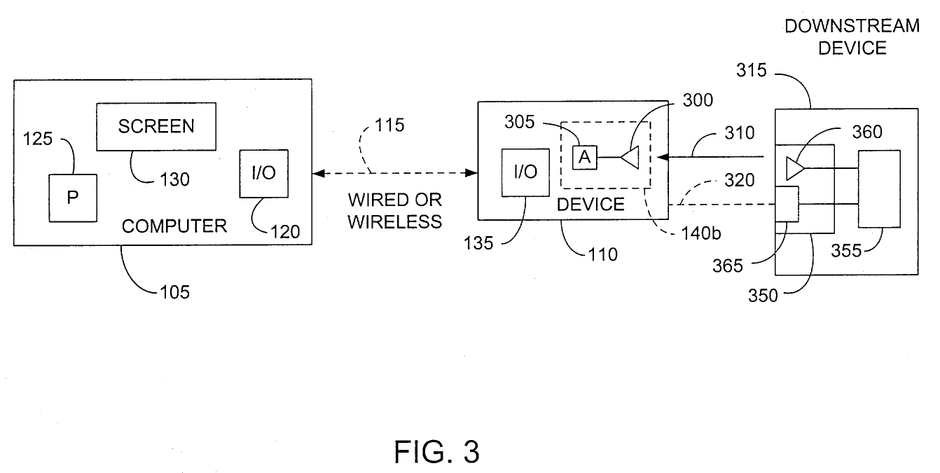

As another example as shown in FIG. 3, an input-function module 140b may include an input stage 300 that may be a receiver (or transceiver) and an amplifier stage 305 for amplifying to signals from the receiver. The receiver can receive a wireless input signal(s) 310 from a user via a device 315 such as, for example, a remote control device, microphone, network node, digital camera, infrared (I/R) blaster, another computer or processing device, and/or other types of devices. For example, the device 315 may be a node, in which case, the communication path defined by the input signal 310 is a network path. The input signal 310 is received by the receiver and amplified by the amplifier 305 and transmitted via communication link 115 to permit the computer 105 to perform desired functions. As another example, the device 315 may include a remote control device for sending inputs 310 or other commands to the variable-function device 110. As noted above, in some instances, an input (such as the input 310) to the variable-function device 110 is not necessarily transmitted via communication link 115 to the computer 105.

The device 315 may include, for example, an output interface 350 and a source 355 to permit the transmission of the signals 310 to the variable-function device 110. The interface 350 may include, for example, a transmitter (or transceiver) 360, a signal driver 365, and/or other suitable components to permit the transmission of the signals 130.

The input signal 310 may be, for example, infrared signals, RF signals, and/or other wireless commands or signals. The receiver 300 may also be configured to receive other frequencies of the electromagnetic spectrum such as, for example, Ultrahigh Frequency (UHF), Very High Frequency (VHF), microwave, and/or other frequencies. The input signals 310 may also be wire-transmitted signals if an optional wire or bus link 320 is implemented between the variable-function device 110 and the device 315.

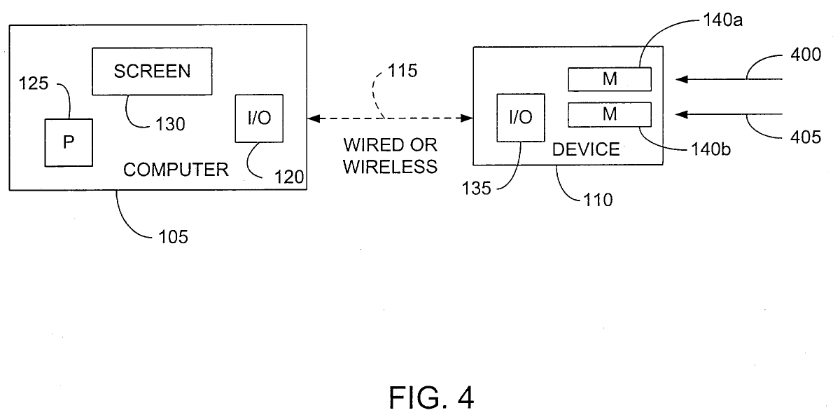

As another example as shown in FIG. 4, the variable-function device 110 may be configured with multiple input modules 140a and 140b to permit multiple types of input-related functionalities. For example, the variable-function device 110 may be configured with multiple input modules to permit the variable-function device 110 to receive both manual user inputs 400 and wireless input commands 405 in order to permit the computer 105 to perform desired functions by use of the variable-function device 110. The number of input modules in the variable-function device 110 may vary. Thus, in one embodiment, the modules 140a and 140b can perform different input functionalities or/and similar input functionalities.

In one embodiment, a method of manufacturing the variable-function device 110 includes providing a module configured to provide a functionality. The variable-function device 110 is configurable to support a second module for providing an additional functionality. At least a second module can be included in or integrated with the variable-function device 110 in order expand the functionality of the device 110.

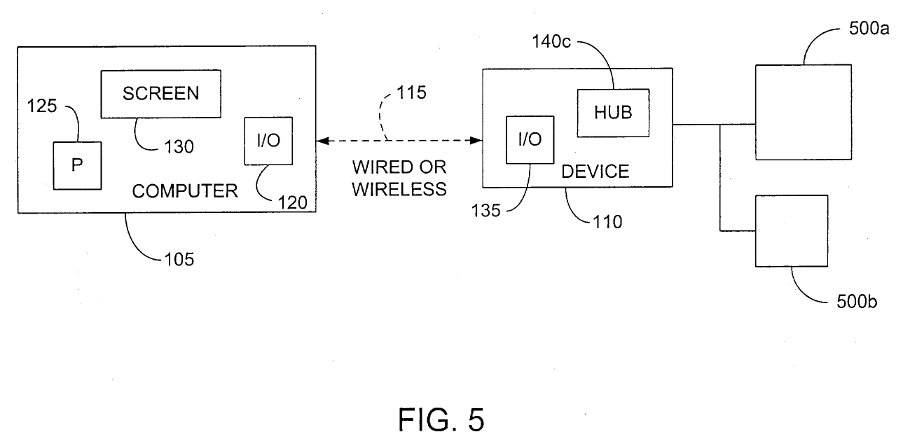

As shown in FIG. 5, if, for example, the input-function module 140c includes a USB hub or another type of bus hub, then at least one device 500 (e.g., devices 500a and 500b) can be coupled to the input-function module 140c. The devices 500 may be, for example, key boards, mices, and/or other peripheral devices, and/or other suitable devices.

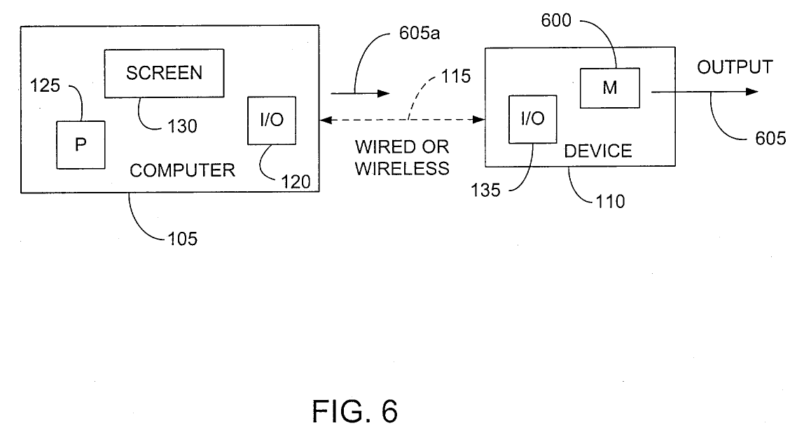

FIG. 6 is a block diagram of a variable-function device 110 in accordance with another embodiment of the invention. The variable-function device 110 includes an output-function module 600 that can transmit an output 605 to a user (or to another device), where the output 605 may represent an output function (or output functionality) as described in detail below. A control signal (or control signal with data) 605a from the computer 105 is typically transmitted via communication link 115 and is processed by I/O interface 135. The output 605 is then generated by the output-function module 600 based upon the signal 605a from the computer 110. Examples of different types of outputs 605 from the output-function module 600 are described below.

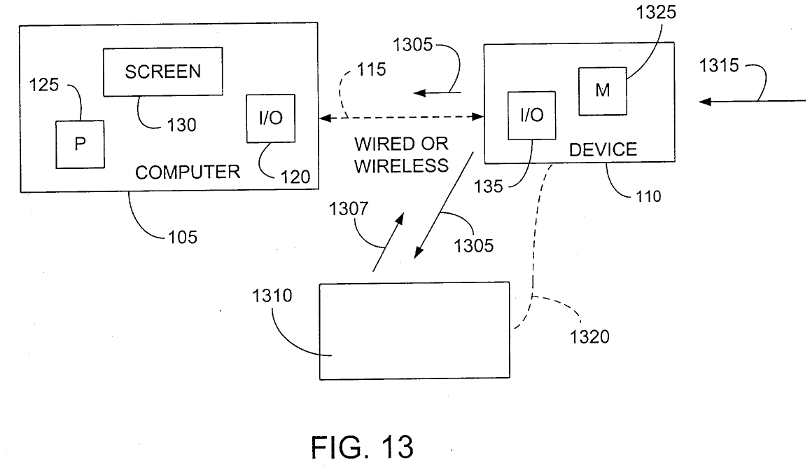

As another example, an output 605 may be generated based on a signal provided by another device that can communicate with the variable-function device 110. One example of such another device is a device 1310 (FIG. 13) which can provide an input 1307 to permit an output-function module 600 to perform a particular output functionality.

Reference is again made to FIG. 6. Various known design schemes or methods for integrating a component in a device may be used to integrate or include an output-function module 600 in a variable-function device 110. An example of a suitable design scheme or method may be of the type used for manufacturing the product known as JORNADA from HEWLETT-PACKARD COMPANY.

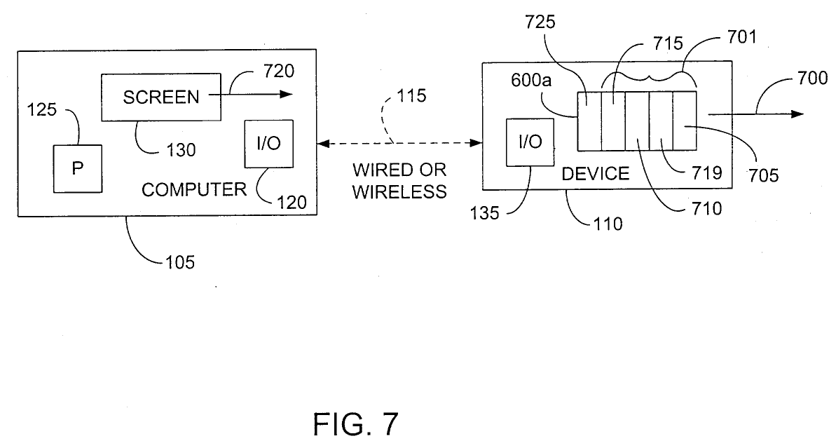

As an example as shown in FIG. 7, the output-function module may be a module 600a to provide notifications (and/or warnings/alerts, video, pictures, photographs, images, advertisements, logos, and/or other output) 700 to a user by use of, for example, an output stage 701. The output stage 701 may be, for example, a display screen 705 to display an alert message, to show a picture, photograph, image, advertisement, video, logo (e.g., the HP logo), and/or to indicate other output 700. Alternatively or additionally, the output stage 701 may also include, for example, a light emitting element (e.g., LED) 710 that turns on to alert the user. In addition or alternatively, the notification 700 may be a sound or audio signal that is emitted from a sound emitting element 715 which may be, for example, a speaker. The sound emitting element 715 may be part of or may form the output stage 701. Alternatively or in addition, the output stage 701 may include a motion-actuating element 719 that triggers motions such as vibrations, movements of movable parts of the variable-function device 110, and/or other types of motions/movements as an output 700. Other types of output generating elements or methods may be used by the output stage 701. An output interface 725 may process the output 700 before being shown via the output stage 701. In one embodiment, a content, image, or program 720 being shown in the computer screen 130 is not interrupted or disturbed by a notification or alert message that current devices show on the screen 130. An embodiment of the invention will show or otherwise indicate this notification or alert message as output 700 via output stage 701.

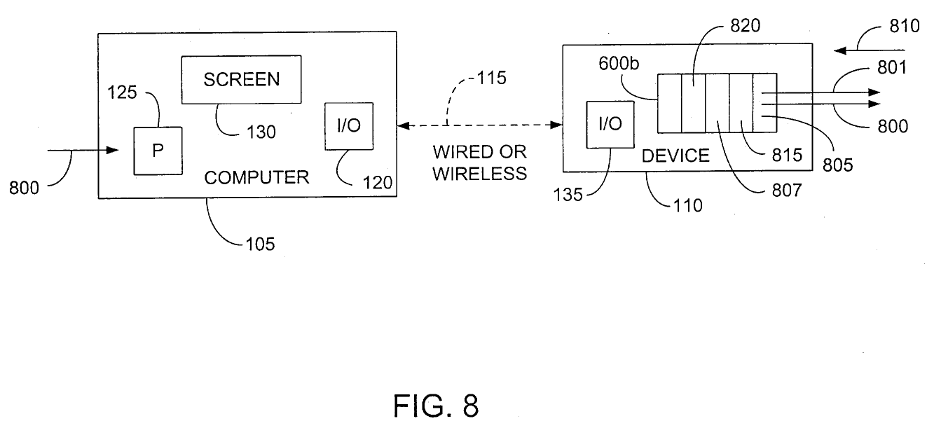

As another example as shown in FIG. 8, if an e-mail or instant message 800 is received by the computer 105, then the processor 125 will forward the e-mail or instant message 800 and an e-mail or instant message arrival notification 801 to the variable-function device 110 via communication link 115. An e-mail or instant message arrival notification 801 can be output by output stage 805 of output-function module 600b. As similarly described above, the output stage 805 may include, for example, a screen for displaying the notification 801 and/or the e-mail or instant message 800, a light emitting element for indicating a message arrival 801, a speaker or other sound-emitting element for indicating a message arrival 801, a motion actuation element for indicating a message arrival 801, and/or other types of elements capable of indicating a message arrival 801. In one embodiment, the module 600b may include a text-to-speech module 807 for converting the text of the e-mail message or instant message into speech sounds.

In embodiments where the variable-function device 110 can receive input commands from a user, the user may provide an input 810 to the variable notification device 110 to permit the text and/or attachment(s) of the e-mail message to be displayed (or converted into speech sounds in one embodiment). In one embodiment, the module 600b may include an e-mail engine (and/or e-mail client) 815 (and/or an instant messaging engine) to permit processing of the e-mail or instant message. The module 600b may also include a processor to permit the processing and display of the text and/or attachment(s) of the e-mail message.

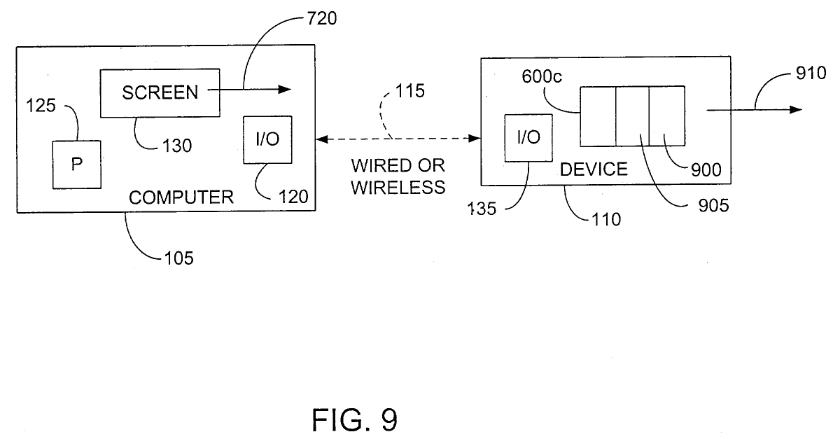

As another example as shown in FIG. 9, the variable-function device 110 may include an output-function module 600c that includes a display screen 900 (or/and other types of displays 905 such as, for example, an LED array). The screen 900 or display 905 may output, for example, entertainment-related information 910 such as the name of a compact disc or movie that is being processed by the computer 105 and/or the like. Alternatively or additionally, in one embodiment the display 900 includes a speaker for indicating the entertainment-related information 901 in speech form. Thus, an embodiment of the invention provides a variable number of types of information or content that can be output by variable-function device 110.

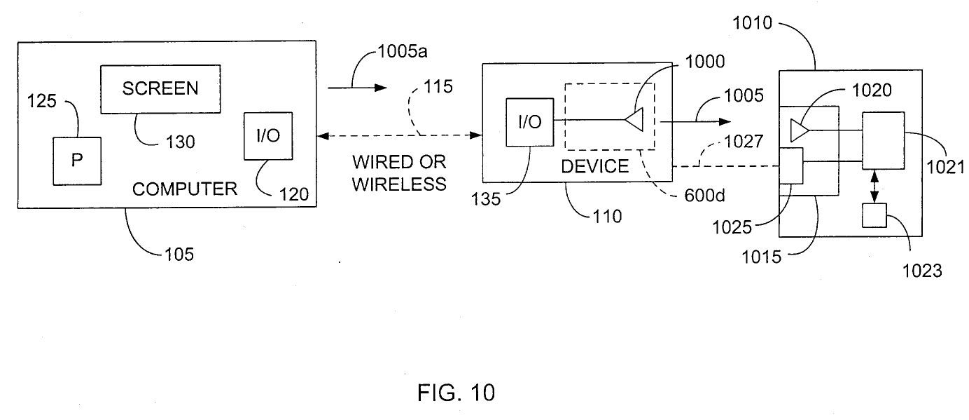

As another example as shown in FIG. 10, an output-function module 600d may include a transmitter (or transceiver) 1000 that can transmit a wireless output signal(s) 1005 to a device 1010 such as remote control device, speaker, network node, a camera monitor, another computer, and/or other types of devices. An input signal 1005a from the computer 105 is received via communication link 115 and processed by the I/O interface 135. Based on the input signal 1005a, the transmitter (or transceiver) 1000 generates an output 1005 to a device 1010. Of course, the output 1005 may be generated in response to other signals that are received by the variable-function device 110, where the other signals may be generated by other devices that can communicate with the variable-function device 110.

The device 1010 may include, for example, an output interface 1015 and a destination stage 1021 for receiving the output 1005 of the variable-function device 110 and generating an event (or permitting a function) in response to the output 1005. For example, the destination stage 1021 may generate via output stage 1023 an output such as alerts, notifications, texts, images, audio or video output, LED or light emissions, motion outputs, and/or other types of output. The interface 1015 may include, for example, a receiver (or transceiver) 1020 for receiving wireless signals, a signal interface 1025 (for receiving signals in implementations with the optional wired or bus link 1027), and/or other suitable components to permit the reception of the output 1005.

The output signal 1005 may be, for example, infrared signals, RF signals, or other wireless commands or signals. The transmitter (transceiver) 1000 may also be configured to transmit other frequencies of the electromagnetic spectrum such as, for example, Ultrahigh Frequency (UHF), Very High Frequency (VHF), microwave, or other frequencies. The output signals 1005 may also be wire-transmitted signals if an optional wired or bus link 1027 is implemented between the variable-function device 110 and the device 1010.

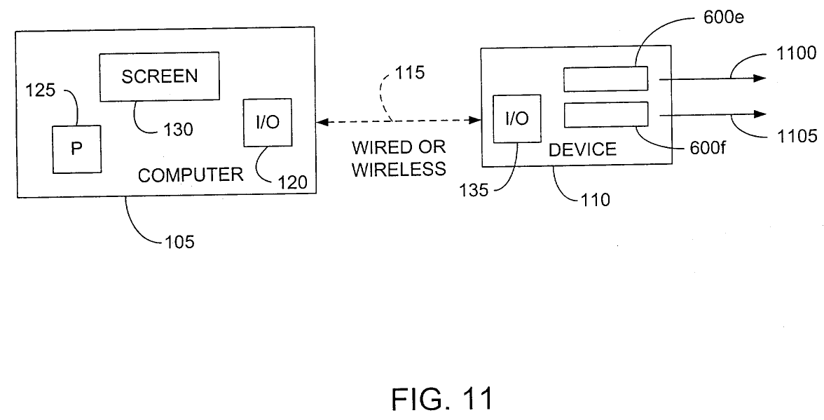

In another embodiment as shown in FIG. 11, the variable-function device 110 may be configured with multiple output-function modules. For example, the variable-function device 110 may be configured with multiple output-function modules 600e and 600f to permit the variable-function device 110 to transmit, for example, both a displayed output 1100 to a user and wireless output commands 1105 to a device (e.g., device 1010 in FIG. 10). The number of output-function modules 600 in the variable-function device 110 may vary.

Other types of output-function modules 600 that can be supported in the variable-function device may include, but not limited to, for example, an I/R blaster, speaker, status display (e.g., in liquid crystal display (LCD) or vacuum florescent), USB hub or other bus hubs, an Ethernet or LAN connection, light-emitting elements, sound-emitting stages, other notification or alert devices, a motion-enabling stage for causing a vibration or other motions to alert a user, a clock, an alarm clock, a display for showing pictures, and/or other types of modules that permit particular functions. The different types of output-function modules 600 may be included or integrated in the variable-function device 110 to permit a variable number of output-related functions to be supported by the variable-function device 110.

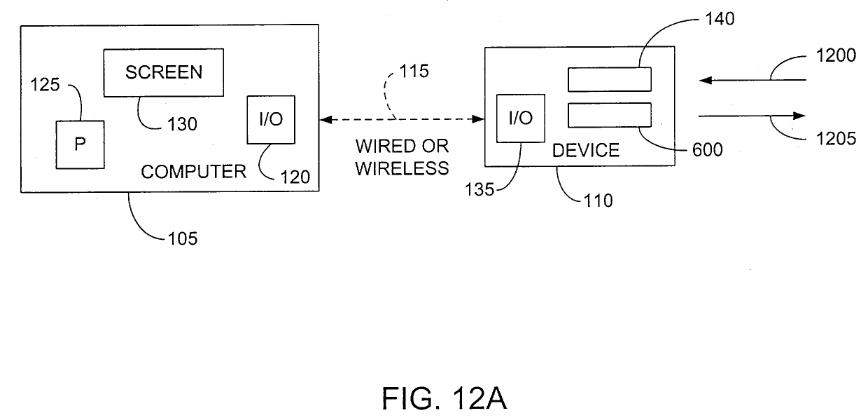

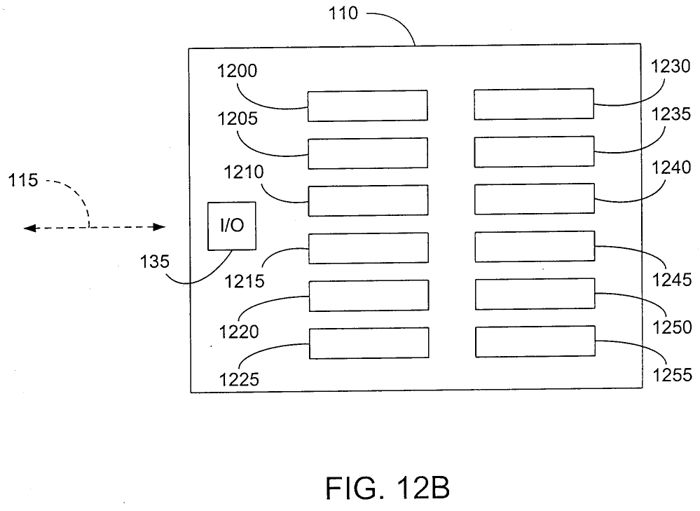

FIG. 12A is a block diagram of a variable-function device 110 in accordance with another embodiment of the invention. The variable-function device 110 includes an input-function module 140 to permit input-related functions based on input 1200 and output-related functions as represented by output 1205. The number of input-function modules 140 and output-function modules 600 may vary to permit the variable-function device 110 to have a variable number of functions.

FIG. 12B is a block diagram of a variable-function device 110 in accordance with another embodiment of the invention. In this embodiment, the variable-function device 110 may include at least one of the function modules 1200, 1205, 1210, 1215, 1220, 1225, 1230, 1235, and 1240. There are numerous possible combinations of function modules in FIG. 12B that can be included in or integrated with the variable-function device 110. TABLES 1 through 12 below list possible functionalities for a particular one of the function modules in FIG. 12B.

The module 1200 may provide entertainment and/or information-resource related functions. The module 1200 may provide, for example, at least one of the functions listed in TABLE 1.

TABLE 1
Possible functions for module 1200

Games
eCheat ™ (or other similar Internet Resources)
Gameboy Advance ™
dynamic gamepad (with or without force
feedback)
ePet ™ (or other similar Internet Resource)
eLavaLamp ™
logos (e.g., HP ® logo)
animated and/or non-animated screensavers
other functions

The module 1205 may provide home security and/or data security related functions. The module 1205 may provide, for example, at least one of the functions listed in TABLE 2.

TABLE 2
possible functions for module 1205

intruder alert or burglar alarm
virus detector
firewall penetration
police scanner
biometrics (e.g., fingerprint recognition)
baby monitor
X10 ™ control
private data
other functions

The module 1210 may provide system display and/or system control related functions. The system may be part of, for example, a computer 105 (or another upstream device) that can communicate with the variable-function device 110. The module 1210 may provide, for example, at least one of the functions listed in TABLE 3.

TABLE 3
possible functions for module 1210

central processing unit (CPU) utilization or “power
meter”
turn system on and/or off
mimic display of any connected peripheral (e.g.,
inkjet printer)
connection speed
HP e-helper ™
diagnostics and/or help
OOBE helper
color calibration
simple input device or user interface for (UI) for
children
system status (e.g., Standby, Shutting Down)
other functions

The module 1215 may provide telephony related functions. The module 1215 may provide, for example, at least one of the functions listed in TABLE 4.

TABLE 4
possible functions for module 1215

Caller identification (ID) (may have, e.g.,
audible feature or intelligence/smart feature)
answering machine
Intercom
speaker phone (e.g., conference speakerphone
or Internet speakerphone)
phone (e.g., cell phone, portable phone, phone
with handset or headset)
other functions

The module 1220 may provide messaging related functions and/or communication related functions. The module 1220 may provide, for example, at least one of the functions listed in TABLE 5.

TABLE 5
possible functions for module 1220

instant messenger and/or buddy-list (see also
FIG. 8)
“find-my-friend” application and/or alert
electronic mail (see also FIG. 8)
other functions

The module 1225 may provide alert related functions and/or notification related functions. The module 1225 may provide, for example, at least one of the functions listed in TABLE 6.

TABLE 6
possible functions for module 1225

alarms, text notifications, audio
notification, and/or other types of
notifications (see also FIG. 7)
“You've got mail...” email notification (see
also FIG. 8)
backWeb messages and/or ads
reminders (e.g., Valentine's Day upcoming)
notes and/or scratchpads
behavior monitoring (of user)
repetitive strain injury (RSI) warning
other functions

The module 1230 may provide productivity related functions, such as, for example, home productivity functions and/or office productivity functions. The module 1230 may provide, for example, at least one of the functions listed in TABLE 7.

TABLE 7
possible functions for module 1230

calendar and/or agenda
to-do List and/or manager
office finance and/or home finance (may
interface with finance software such as, for
example, Quicken ™, Quickbooks ™, Timeslips ™,
and/or other finance related software)
Calculator
rolodex and/or contacts
Recipes
calorie counter
exercise program
dictionary and/or thesaurus
other functions

The module 1235 may provide transaction-related functions and/or value-added services. The module 1235 may provide, for example, at least one of the functions listed in TABLE 8.

TABLE 8
possible functions for module 1235

coupon offerings
travel specials
good deal (shopping) alert
Web services
Recommendations
language translator
other functions

The module 1240 may provide functions related to a logical window for a personal computer or other computer such as, for example, the PAVILION™ computer from HEWLETT-PACKARD COMPANY. The module 1240 may provide, for example, at least one of the functions listed in TABLE 9.

TABLE 9
possible functions for module 1240

Module 1240 may provide another logical
window, where activity is tracked on a primary
display (for example, module 1240 can show
information, while the primary display is
showing Windows; and/or module 1240 may show
PC/Computer/Windows information while the
primary display is immersed in other
information).
Module 1240 may also provide a “dual head”
display feature and/or Picture-in-Picture
feature)
Module 1240 may provide a virtual second
monitor (which may or may not be independent
of Windows)
other functions

The module 1245 may provide educational related functions. The module 1245 may provide, for example, at least one of the functions listed in TABLE 10.

TABLE 10
possible functions for module 1245

distance learning
homework helper
school (e.g., University) calendar
school (e.g., University) class schedule
other functions

The module 1250 may provide audio and/or visual (A/V) related functions and/or functions related to device control. The module 1250 may provide, for example, at least one of the functions listed in TABLE 11.

TABLE 11
possible functions for module 1250

display “Now Playing:” information (e.g.,
display information about currently playing
compact disc (CD), digital video disc (DVD),
AM/FM program, television program, and/or
other media)
display “Now Recording:” information (e.g.,
information about a program, song, and/or
other media being recorded)
photos and/or digital picture frame
audio status and/or control
TV guide and/or Electronic Program Guide (EPG)
(may have, for example, scrolling feature)
audio-in and/or headphones out
standard A/V display information
speaker calibration
Karaoke information
Equalizer
music playlist
television Picture-In-Picture (PIP) feature,
picture overlay feature, and/or split screen
feature
album and/or compact disc covers
other functions

The module 1255 may provide advanced functions. The module 1255 may provide, for example, at least one of the functions listed in TABLE 12.

TABLE 12
possible functions for module 1255

Web camera
MP3 player
digital camera and/or video recorder
card reader
Global Positioning System (GPS)
heart monitor
night light
voice recorder
ZIP replacement
smart card reader, a memory card reader,
and/or credit card reader
Breathalyzer
lie detector
motion detector
CapShare
Richter meter and/or earthquake detector
Biofeedback
other functions

Other types of function modules that can be supported in an embodiment of the variable-function device 110 may include, but not limited to, for example, media transport control buttons, a USB hub or other bus hubs, a removable storage device, an Ethernet or LAN connection, and/or other types of elements or features that permit particular functions.

FIG. 13 is a block diagram of a variable-function device 110 in accordance with another embodiment of the invention. The variable function device 110 is configured to transmit signals 1305 to the computer 105. In addition or alternatively, the variable-function device 110 is configured to transmit the signals 1305 to a receiving device 1310 to permit particular functions to be performed by the device 1310 (e.g., an upstream device). For example, in response to a manual or wireless input 1315 to the variable-input device 110, the variable-function device 110 may transmit a wireless signal (e.g., an infrared command signal) 1305 to the device 1310 so that the device 1310 can perform a particular operation and/or an event is triggered in the device 1310. The signal 1305 may also be transmitted to the device 1310 via an optional wired link 1320. For example, the device 1310 may be a television or stereo that turns on in response to a particular infrared command signal 1305. As another example, the device 1310 may be a home automation server that permits particular home automation functions to be performed in response to the signal 1305. As noted above, the variable-function device 110 can also receive input signals 1307 from the device 1310 to, for example, trigger an event and/or operation by the module 1325 in the variable-function device 110.

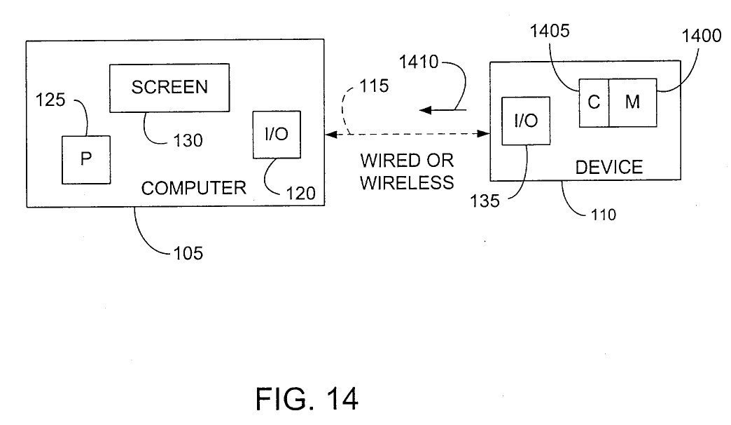

FIG. 14 is a block diagram of a variable-function device 110 in accordance with another embodiment of the invention. The variable function device 110 may include a module 1400 for alerting or triggering the computer 105 to perform particular functions at, for example, a scheduled time. In one embodiment, the module 1400 includes a clock 1405 to permit the module 1400 to generate an event triggering signal 1410 to turn on the computer 105 and permit the computer 105 to perform, for example, a scheduled event. In one particular instance, the computer 105 may be switched from an off-state into an on-state in response to the event triggering signal 1410.

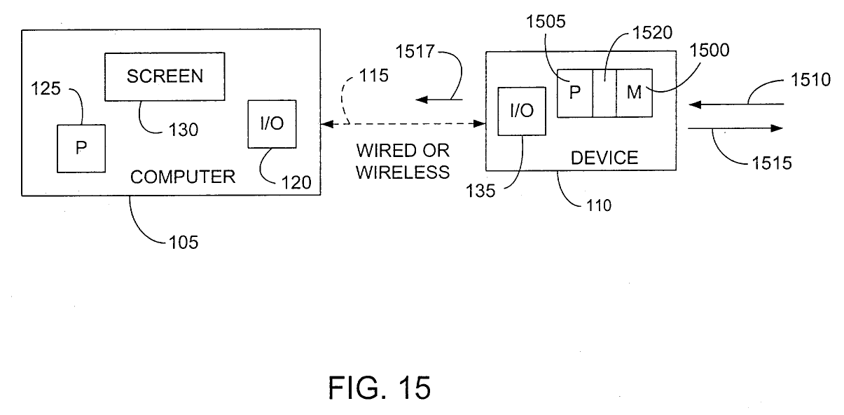

FIG. 15 is a block diagram of a variable-function device in accordance with another embodiment of the invention. The variable function device 110 may include a module 1500 that includes a processor 1505. This processor 1505, for example, performs processing tasks to enable some input-related tasks (or functions) 1510 and/or output-related tasks (or functions) 1515 and/or functions 1517 related to a device (e.g., computer 105) that can communicate with the variable-function device 110. Alternatively or additionally, the processor 1505 may perform some processing functions that can be performed by the processor 125 in the computer 105. Thus, the variable-function device 110 permits at least some processing functions to be shifted from the computer 105 to the variable-function device 110.

The processor 1505 may be embodied as, for example, a micro-controller, microprocessor, digital signal processor (DSP), Application Specific Integrated Circuit (ASIC), programmable logic device (PLD), field programmable gate array (FPGA), or other suitable devices.

The module 1500 in the variable-function device may also include a memory (storage element) 1520 that can store various software or firmware. For example, the software may be an operating system or an executable program for an application such as electronic mail or web browser. The firmware provides instructions to the processor 1500 for certain functions so that the processor 1500 can launch certain programs or perform other functions independently of the computer 105.

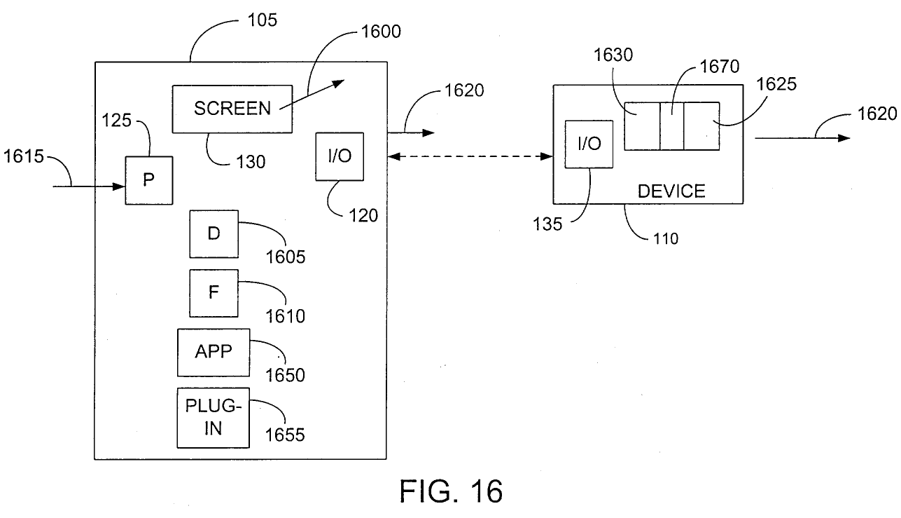

FIG. 16 is a block diagram of a variable-function device 110 in accordance with another embodiment of the invention. Assume that the screen 130 of the computer 105 is displaying content 1600 that the user does not want to be interrupted. For example, the content 1600 may be a movie or an output of a program being executed by the computer processor 125. A device driver 1605 and filter software 1610 may be programmed to detect for particular events so that when these particular events 1615 occur, then a content 1620 related to these events (event-related content 1620) is instead transmitted by the device driver 1605 via communication network 115 and generated by an output stage 1625 of a module 1630 of the variable-function device 110. Depending on the elements that form the output stage 1625 (e.g., display screen, speakers, light-emitting elements, and/or the like), the content 1620 may be made observable to the user as, for example, an image, video, text, audio sound, motion, light emission, and/or other types of output. Therefore, an embodiment of the invention prevents the interruption of content 1600 that is being shown in the computer screen 130.

The event 1615 may be, for example, a notification indicating the arrival of electronic mail or instant message, low-battery power alert, and/or other events that may be detected for by the device driver 1605 and filter software 1610. The filter software 1610 performs a comparison between preset data (that represent particular events) and the event signal 1615 to determine if content representing the event 1615 should be displayed in the variable-function device 110.

Various known methods may be used to permit the output stage 1625 of the module 1630 to generate the event-related content 1620. For example, the filter software 1620 may be code that is in between a driver for the display screen 130 and the application(s) 1650 that sends content to the screen 130. The filter software 1610 may, for example, allow a user to designate the application content that should be generated via the output stage 1625 of the module 1630 in the variable function device 110, instead of generating the application content via the computer screen 130. Thus, the filter software 1610 may allow a user to customize the content shown via the output stage 1625 of the module 1630. Alternatively, the filter software 1610 may have default settings that will cause a particular application content to be generated via the output stage 1625 of the module 1630. Alternatively, the filter software 1610 may allow a particular application content to be generated via the computer screen 130 and the output stage 1625.

Alternatively or additionally, a plug-in 1655 may be used at the application level to allow an application content to be generated via the output stage 1625 of the module 1630 instead of the computer screen 130. The plug-in 1655 may also allow an application content to be generated via the output stage 1625 and the computer screen 130.

Alternatively, as part of a software 1670 in the module 1630 in the variable-function device 110, an application program interface (API) can permit application vendors to program an application content to by-pass the computer screen 130, so that the application content is generated via the output stage 1625 of the module 1630. In this particular implementation, the filtering software 1610 may be omitted when generating application content via the output stage 1625 of the module 1630.

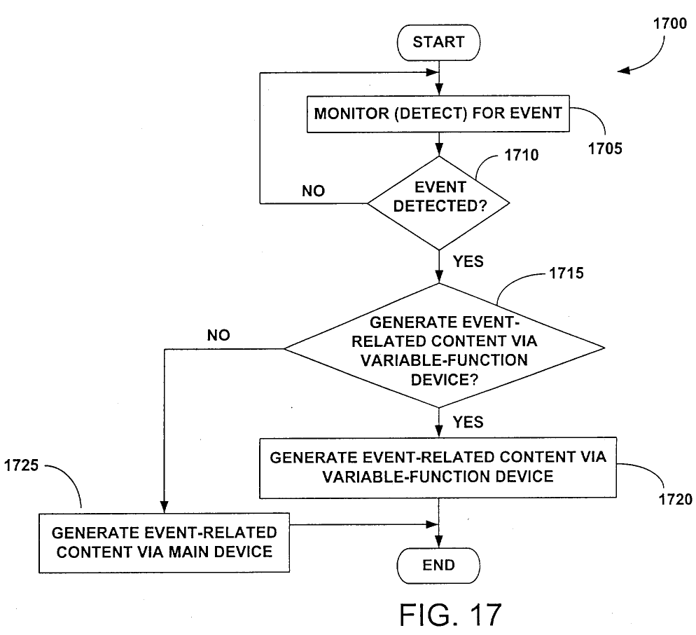

FIG. 17 is a flow diagram of a method 1700 for generating an event-event related content by use of a variable-function device, in accordance with an embodiment of the invention. The method 1700 may run continuously or at representative intervals. Monitoring (1705) for an event is first performed. Upon a detection (1710) of an event, a determination is made (1715) if a content related to the event (event-related content) should be generated via an output stage of the variable-function device. If so, the event-related content is generated (1720) via the output stage. The event-related content may be output as, for example, an image, a notification, an audio sound, and/or another type of output. Otherwise, in step (1715), the event-related content is generated (1725) via an output stage of the main device (e.g., a screen of a computer).

In another embodiment, if a determination is made (1715) that the event-related content should be generated via the output stage of the variable-function device, then the event-related content may be generated via the output stage of the variable-function device and via the output stage of the main device (e.g., the screen of the computer).

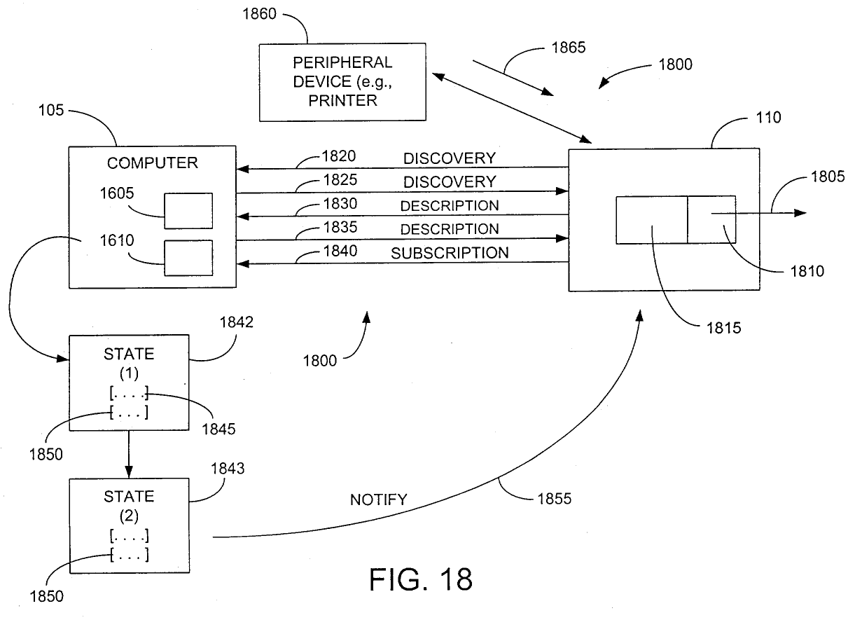

In another embodiment as shown in FIG. 18, the computer 105 and variable-function device 110 may be connected to a network 1800 and may use the Universal Plug and Play (UPnP) standard. UPnP is a standard that uses Internet and Web protocols to enable devices such as PCs, peripherals, intelligent appliances, and wireless devices to be plugged into a network and automatically know about each other. With UPnP, when a user plugs a device into the network, the device will configure itself, acquire an Internet Protocol (IP) address, and use a discovery protocol based on the Internet's Hypertext Transfer Protocol (HTTP) to announce its presence on the network to other devices. Thus, an event occurrence can be handled by the eventing mechanism of UPnP. The device driver 1605 and filtering software 1610 can then determine if the announced event requires filtering. If so, then the event-related content is transmitted via network 1800 to the variable-function device 110 to permit the generation of an output 1805 (e.g., display image and/or audio alert) via output stage 1810 of the module 1815. The output 1805 may be the event-related content or information indicating a state change of a device connected to the network 1800.

As noted above, a first phase in the UPnP standard is the addressing phase, where, typically, a device that is added to the network 1800 will try to locate a Dynamic Host Configuration Protocol (DHCP) server on the network 1800 in order to acquire an IP address. After the addressing phase, a discovery phase occurs where the added device will broadcast its existence to the network 1800 by use of, for example, a multi-cast version of the Hypertext Transfer Protocol (HTTP) and attempt to obtain information about other devices in the network 1800. In FIG. 18, during a discovery phase, the variable-function device 110 sends a broadcast 1820, while the computer 105 sends a broadcast 1825.

After the discovery phase, a description phase occurs where a device in the network 1800 can learn about other devices based upon the descriptions of the devices. A description typically includes a state vector that describes the state of the device. In FIG. 18, the variable-function device 110 sends a request 1830 to the computer 105 for a device description, and, in response to the request, the computer sends the device description 1835 to the variable-function device 110. The device description 1835 includes information about the computer 105 and state information 1842 with a state vector 1845 describing the state of the computer 105. The variable-function device 110 can send a signal 1840 to subscribe to events that change a state of the computer 105, and this subscription is indicated in the representation 1850 which identifies all subscribing devices. The state information 1842 may be stored in, for example, an internal or external memory of the computer 105 or in other suitable locations such as a website.

It is further noted that the device description 1835 of the computer 105 may include hooks for controlling the computer 105. The device description 1835 permits the computer 105 to inform the variable-function device 110 on how the variable-function device 110 can control the computer 105. A standard mechanism to permit control of devices is the Simple Object Access Protocol (SOAP). In FIG. 18, the variable-function device 110 can send SOAP signals to effect changes in the computer 105. As an example, the device description 1835 may provide a Uniform Resource Locator (URL) that provides a description for controlling the computer 105.

When the state of the computer 105 changes, the state information 1842 changes to state information 1843, with changes occurring in the state vector 1845. The subscribed devices (including variable-function device 110) are then notified via notification 1855 from the computer 105 of the state change in the computer 105. Content that is associated with the state change can be generated as an output 1805 by the output stage 1810 of the module 1815.

The variable-function device 110 may subscribe to other events (or state changes) that occur in another device in the network 1800. For example, the variable-function device 110 may subscribe to events in a peripheral device 1860 (e.g., a printer). If there is a state change in the peripheral device 1860 (e.g., a printer paper jam), then the peripheral device 1860 transmits a notification 1865 to the variable-function device 110. Based on this notification 1865, the output stage 1810 of the module 1815 can generate an output 1805 related to the notification 1865. Thus, the variable-function device 110 can mimic notifications generated by another device, if the variable-function device 110 subscribes to the other device. For example, if a printer paper jam condition occurs in the peripheral device 1860, then the message “printer paper jam” can be generated by the output stage 1810 of the module 1815. It is further noted that the module 1815 can control any suitable device (e.g., peripheral device 1860, computer 105, and/or other suitable devices) by use of the UPnP standard.

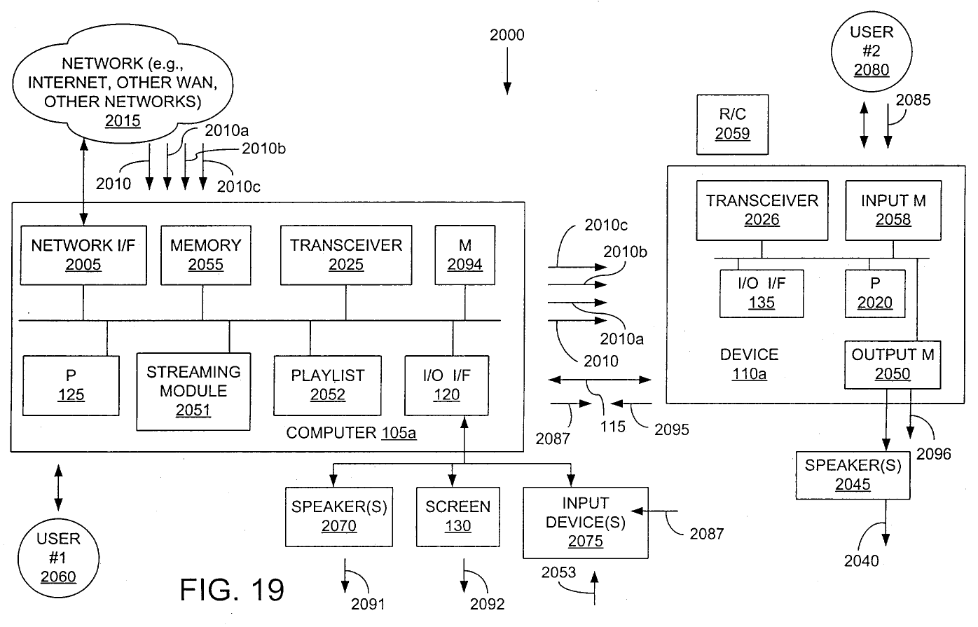

FIG. 19 is a block diagram of a multi-user entertainment system 2000, in accordance with an embodiment of the invention. In an embodiment, a computer 105a can communicate with a variable function device 110a via link 115. The link 115 may be a wired or wireless link. The computer 105a may be, in one embodiment, a home entertainment computer that is configured to provide home entertainment functions. However, the computer 105a may also be another type of computing device such as a personal computer, notebook computer, laptop, palmtop, server, micro-computer, mini-computer, workstation, or another suitable type of computing device. In an embodiment, the variable function device 110a is preferably a compact minimum size device that is portable, lightweight, and requires minimum “real estate” area.

In an embodiment, the computer 105a includes a network interface 2005 that can receive data (or signal(s)) 2010 from a communications network 2015. The data 2010 may be, for example, audio data such as MPEG-1 Audio Layer-3 (MP-3) files 2010a or Internet radio broadcast signals 2010b. As known to those skilled in the art, MP-3 is a standard technology and format for compression of a sound sequence into a very small file (e.g., about one-twelfth the size of the original file), while preserving the original level of sound quality when the file is played. Typically, MP-3 files (which are identified with the file name suffix of “.mp3”) are available for downloading from a number of Web sites.

Additionally, the data 2010 may be other data 2010c such as audio signals from a television program, audio signals in a streaming video from the Internet, another type of audio signal, a video signal, or another type of signal/data. It is noted that the term “data” herein may include content data, as well as control data, identifiers, and/or other types of data.

The data 2010 may be obtained generally from the communication network 2015, which may be, for example, the Internet or another type of public wide area network (public WAN), a private wide area network, a cable network, a satellite communication network, a telephone or telecommunications network, or another type of communication network.

As an example, when the network interface 2005 receives the data 2010 (such as, e.g., MP-3 files/data 2010a, Internet radio broadcast signals/data 2010b or other signals/data 2010c), the processor 125 may process the data 2010 for output by the I/O interface 120 or the transceiver 2025 across the link 115. If the link 115 is a wired link, then the I/O interface 120 will output the data 2010 which is then received by the I/O interface 135 of the variable function device 110a. If the link 115 is a wireless link, then the transceiver 2025 will output the data 2010 which is then received by the transceiver 2026 of the variable function device 110a. In another embodiment, the transceiver 2025 is a transmitter and the transceiver 2026 is a receiver. In another embodiment, the transceiver (or transmitter) 2025 plugs into the I/O interface 120 which may be, for example, a USB port. In an embodiment, the transceiver (or receiver) 2026 in the variable function device 110a may also plug into the I/O interface 135 which may be, for example, a USB port. Alternatively, the transceivers 2025 and 2026 may be omitted if the I/O interfaces 120 and 135 are configured to transmit and/or received signals in a wireless manner. The received data 2010 is then processed by the variable function device 110a, as described below.

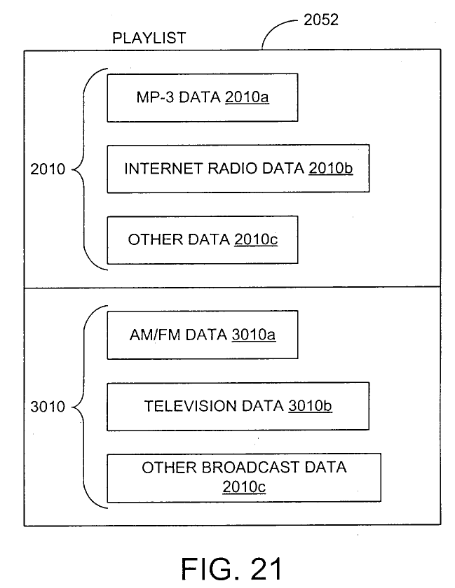

In another example, when the network interface 2005 receives the data 2010, the processor 125 may store the data 2010 as a playlist 2052 in the memory 2055 or in other suitable memory device. In FIG. 19, the playlist 2052 is illustrated as being external to the memory 2055 for purposes of describing a functionality of an embodiment of the invention. As best shown in FIG. 21, the playlist 2052 may include stored data 2010 from the network 2015, where the data 2010 may include, for example, MP-3 data 2010a, Internet radio broadcast data 2010b, and/or other data 2010c.

Referring again to FIG. 19, in response to an input command(s) 2053 (hereinafter “input command 2053”) from a first user 2060, the processor 125 can then retrieve the data 2010 (such as the MP-3 data 2010a, Internet radio broadcast data 2010b, and/or other data 2010c) from the playlist 2052 and process the data 2010 for output by the I/O interface 120 or the transceiver 2025. The first user 2060 may input the command 2053 by use of, for example, an input device(s) 2075 (hereinafter “input device 2075”) which may be a keyboard, mouse, touch-screen device, and/or another suitable device that can accept input from a user or from another device such as a remote control device. It is also noted that the input device 2075 may be built in (or integrated with) the computer 105a.

Alternatively or additionally, a second user 2080 can input a command(s) 2085 (hereinafter “input command 2085”) in an input module 2058 in the variable function device 110a. The input command 2085 is then processed by a processor 2020 to generate a signal(s) 2095 (hereinafter “signal 2095”) which is then transmitted across the link 115. In response to a particular transmitted signal 2095, the processor 125 can retrieve a data 2010 in the playlist 2052 and can process the data for output via I/O interface 120 or via transceiver 2025 across the link 115 to the variable function device 110a. Depending on the type of command 2053 or command 2085, the processor 125 can retrieve at least a particular one of the MP-3 files 2010a, Internet radio broadcast data 2010b, and/or other data 2010c for transmission across the link 115 to the variable function device 110a. The variable function device 110a is configured to permit the second user 2080 to enable the computer 105a to perform various desired functions that were described above. Thus, the second user 2080 is not required to use the input device(s) 2075 in order to permit the computer 105a to perform particular functions such as the streaming of data 2010, data collection 2087, or other data from the computer 105a to the variable function device 110a for output as a signal 2040 that can be perceived by the second user 2080 (and/or by the first user 2060).

In an embodiment, the input command 2085 may be directly entered by the second user 2080 into the input module 2058, or the second user 2080 may remotely transmit the input command 2085 to the input module 2058 by use of a remote control device 2059. In another embodiment, the input module 2058 may be omitted if the transceiver 2026 (and/or I/O interface 135) is configured to receive the input command 2085 from the remote control device 2059, where the input command 2085 is then processed by the processor 2020. In yet another embodiment, the output module 2050 may be omitted if the transceiver 2026 (or/and the I/O interface 135) is configured to transmit audio output signals to a speaker(s) 2045 (hereinafter “speaker 2045”) to permit the speaker 2045 to generate the audio output signals 2040.

Additionally or alternatively, a data collection 2087 (such as, for example, at least one compact disk, digital video disk (DVD), audio tape, digital tape, video tape or audio data from a video tape, and/or another audio source) may also be input by the first user 2060 into the input device 2075. Thus, the input device 2075 may include, for example, at least one of a compact disk player, DVD player, disk drive, audio tape player, digital tape player, camcorder, digital camera, video cassette recorder (VCR), or another device, or a particular device that can perform a combination of functions that are performed by at least some of these aforementioned example devices. In response to a particular command (or particular setting) 2053 from the first user 2060, the processor 125 can process at least a particular one of the data collection 2087 for output by the I/O interface 120 or by the transceiver 2025 for transmission across the link 115 to the variable function device 110a. As an example, the data collection 2087 may be audio files (such as songs) in a compact disk that is inserted into the input device 2075. Copies (images) of the audio files in the compact disk are then processed by the processor 125 for output via I/O interface 120 (or via transceiver 2025) along the link 115, and the copies of the audio files from the data collection 2087 are then received and processed by the processor 2020 in the variable function device 110a for output as signal 2040.

The data 2010 from the network 2015, data collection 2087, and/or other signals/data may also be output as audio output 2091 via speaker 2070 or/and as visual output 2092 (e.g., video, images, pictures) via screen 130. The speaker 2070 and screen 130 may be other types of suitable output devices for generating output signals that are perceivable to the first user 2060. Of course, the speaker 2070 and screen 130 may be built in (or integrated with) the computer 105a. The audio output 2091 and visual output 2092 may be perceived by the first user 2060 for, e.g., entertainment purposes.

Typically, the computer 105a includes a sound card for processing the audio data in the signal 2010 or in the data collection 2087. The sound card may be implemented in, for example, the processor 125, streaming module 2051, or other suitable components that can communicate with the processor 125. Similarly, the variable function device 110a typically includes a sound card for processing the audio data in the signal 2010, in the data collection 2087, and in other received signals. The sound card may be implemented in, for example, the processor 2020, output module 2050, or other suitable components that can communicate with the processor 2020.

In one embodiment, the variable function device 110a includes the processor 2020 for processing the data 2010 (or data in data collection 2087 or signals) that has been transmitted by the computer 105a via link 115. The data 2010 (or data collection 2087) may then be generated as an audio output 2040 via the output module 2050 and speaker 2045. Alternatively, the variable function device 110a may include an output module 2050 with a speaker(s) for generating the output signal 2040 that is perceivable to a user such as the second user 2080.

In yet another embodiment, the output module 2050 includes a radio tuner/receiver for receiving and broadcasting AM or FM broadcast audio signals and/or audio signals from television broadcast signals. These audio signals may be generated as output audio signals 2040 from the speaker 2045 or from the output module 2050 if the output module 2050 includes a speaker(s).

The output module 2050 may also function as an alarm clock and generate the output signal 2040 as an alarm signal. As such, the output module 2050 may be configured to include a display for showing, for example, the current time or date, the preset alarm time, and/or the currently selected broadcast station.

In all of the above-mentioned functions or operations, the audio output 2040 can be perceived by the second user 2080 for, e.g., entertainment purposes or alert/notification purposes.

In one embodiment, the computer 105a includes the streaming module (or/and software) 2051 which may be stored in, for example, the memory 2055. The streaming module 2051 permits the processor 125 to process the data 2010 and/or data collection 2087 (or other data) in a conventional manner so that the data 2010 or data collection 2087 (or other data) is streamed from the computer 105a to the variable function device 110a via link 115. Thus, in this embodiment, the computer 105a is functioning as a streaming audio server for streaming the data 2010 or data collection 2087 via link 115 to the variable function device 110a, while the variable function device 110a is functioning as a client for receiving the streamed data and for generating the streamed data as output signals 2040. Typically, the data 2010 or data collection 2087 is not stored by the variable function device 110a and is immediately generated as output signals 2040 by the variable function device 110a. Thus, the use of the computer 105a and the variable function device 110a enables a unique data streaming entertainment system or audio streaming entertainment system.

In an embodiment, the first user 2060 can personalize, preset, or preselect the particular data (e.g., data 2010, data collection 2087, or other data) to stream from the computer 105a to the variable function device 110a (via link 115) by use of a particular input command(s) 2053 via input device(s) 2075. The particular input command 2053 will program the processor 125 in selecting the particular data to stream via link 115 to the variable function device 110a. Alternatively or additionally, the second user 2080 can personalize, preset, or preselect the particular data (e.g., data 2010, data collection 2087, or other data) to stream from the computer 105a to the variable function device 110a (via link 115) by use of a particular input command(s) 2085 via input module 2058. The remote control device 2059 may be used to transmit the input command 2085 to the input module 2058. In response to the input command 2085, the processor 2020 in the variable function device 110a transmits a particular signal 2095 to the computer 105a. In response to the particular signal 2095, the processor 125 in the computer 105a can select the particular data to stream from the computer 105a via link 115 to the variable function device 110a.

Additionally, the computer 105a may include at least one module 2094 which may be, for example, a computer software game, a word processing program, and/or another computer program(s). The module 2094 is typically stored in the memory 2055 or in an input device 2075 (e.g., in a disk drive) and is executed by the processor 125 so that the module 2094 generates audio output 2091 via speaker 2070 and/or visual output 2092 via screen 130. For example, if the module 2094 includes a computer software game, then the audio output and/or visual output of the computer software game are generated via speaker 2070 and screen 130, respectively, to provide an entertainment function to the first user 2060.

Thus, in the embodiment shown in FIG. 19, a first user 2060 may use the computer 105a and hear audio signals (e.g., signals 2010, data collection 2087, or other audio data) via speaker 2070. The first user 2060 may also view the visual output signals 2092 via screen 130 and control the computer 105a (or module 2094) via input device 2075. Additionally, a second user 2080 can hear audio signals (e.g., audio data 2010 or data collection 2087) that are transmitted from the computer 105a to the variable function device 110a, and the audio signals are then generated from, for example, the speaker 2045 or output module 2050. The particular signal output 2091 (and/or signal output 2092) directed to the first user 2060 and the particular signal output 2040 directed to the second user 2080 may be distinct or different from each other, depending on the particular input commands 2053 to control the processor 125 and/or the particular input commands 2085 to control the processor 2020. Conventional methods may then be used to permit the processor 125 to separate the first particular audio signal (which is generated as output signal 2091 from the computer 110a) from the second particular audio signal (which is generated as output signal 2040 from the variable function device 110a). Thus, the entertainment system 2000 can provide different forms of entertainment functions to different users 2060 and 2080.

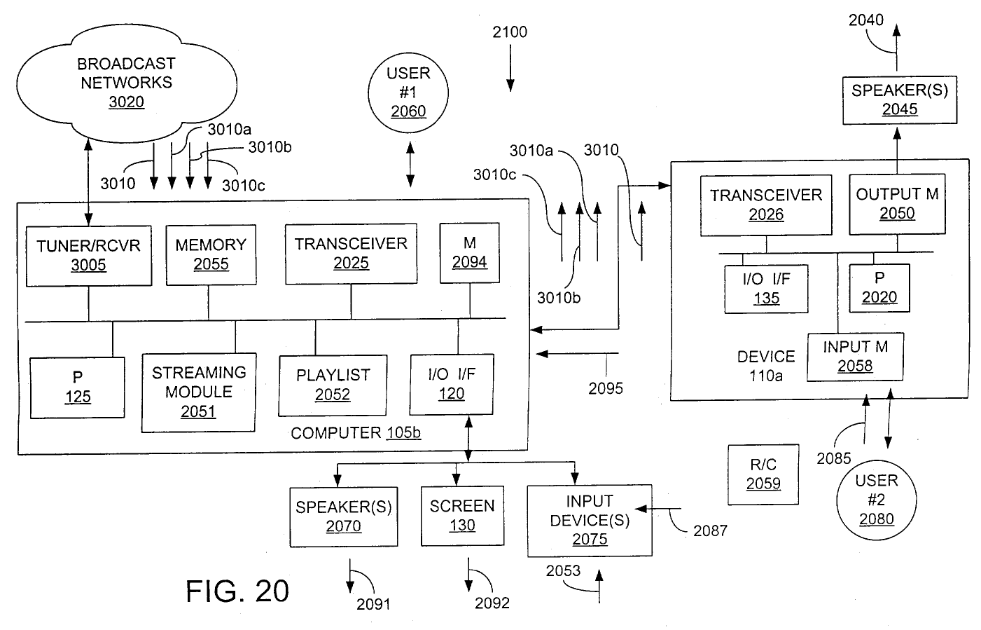

Referring now made to FIG. 20, there is shown a multi-user entertainment system 2100, in accordance with another embodiment of the invention. The entertainment system 2100 includes a computer 105b that can communicate with the variable function device 110a. In one embodiment, the computer 105b is a home entertainment computer that is configured to provide home entertainment functions. However, the computer 105b may also be another type of computing device such as a personal computer, notebook, laptop, palmtop, server, micro-computer, mini-computer, workstation, or another suitable type of computing device.

In an embodiment, the computer 105b includes a tuner/receiver 3005 that can receive broadcast data (signal(s)) 3010 from a broadcast network(s) 3020 (hereinafter “network 3020”). The broadcast data 3010 may include, for example, AM and/or FM radio signals 3010a, television signals 3010b, and/or other broadcast signals 3010c such as audio signals from a broadcast signal. The network 3020 may include, for example, a television network, a radio network, and/or other types of broadcast networks.

In another embodiment, the tuner/receiver 3005 can be implemented in the computer 105a in FIG. 19, so that the computer 105a can additionally receive and process AM and/or FM radio signals 3010a, television signals 3010b, and/or other broadcast signals 3010c.

As an example, when the tuner/receiver 3005 receives the data 3010 (such as radio signals 3010a, television signals 3010b, and/or other broadcast signals 3010c), the processor 125 may process the data 3010 for output by the I/O interface 120 or the transceiver (or transmitter) 2025 across the link 115. If the link 115 is a wired link, then the I/O interface 120 will output the data 3010 which is then received by the I/O interface 135 of the variable function device 110a. If the link 115 is a wireless link, then the transceiver 2025 will output the data 3010 which is then received by the transceiver (or receiver) 2026 of the variable function device 110a. The received data 3010 is then processed by the variable function device 110a, as similarly described above for the data 2010 of FIG. 19.

In another example, when the tuner/receiver 3005 receives the data 3010, the processor 125 may store the data 3010 as a playlist 2052 in the memory 2055 or other suitable memory device. As best shown in FIG. 21, the playlist 2052 may include stored data 3010 from the broadcast network 3020, where the data 3010 may include, for example, radio data 3010a, television data 3010b, and/or other data 3010c.

Referring again to FIG. 20, in response to a particular input command 2053 from the first user 2060, the processor 125 can then retrieve the data 3010 (such as the radio data 3010a, television data 3010b, and/or other data 3010c) from the playlist 2052 and process the data 3010 for output by the I/O interface 120 or the transceiver 2025.

Alternatively or additionally, the second user 2080 can input a particular command 2085 in the input module 2058 in the variable function device 110a. The input command 2085 is then processed by the processor 2020 to generate a particular signal 2095 which is then transmitted across the link 115. In response to a particular transmitted signal 2095, the processor 125 can retrieve a data 3010 in the playlist 2052 and the data is then output by the I/O interface 120 or by the transceiver 2025 across the link 115 to the variable function device 110a. Based upon the particular command 2053 from the first user 2060 or command 2085 from the second user 2080, the processor 125 can retrieve at least a particular one of the radio data 3010a, television data 3010b, and/or other data 3010c for transmission across the link 115 to the variable function device 110a. The processor 2020 then processes the data 3010 for output as output signal 2040 from the variable function device 110a.

The data 3010 from the broadcast network 3020 may also be output as audio output 2091 via speaker 2070 or/and as visual output 2092 (e.g., video, images, pictures) via screen 130. The audio output 2091 and visual output 2092 may be perceived by the first user 2060 for, e.g., entertainment purposes.

Typically, the computer 105a includes a sound card for processing the audio data in the signal 3010. As noted above, the sound card may be implemented in, for example, the processor 125, streaming module 2050, or other suitable components that can communicate with the processor 125. Similarly, the variable function device 110a typically includes a sound card for processing the audio data in the signal 3010. As noted above, the sound card may be implemented in, for example, the processor 2020, output module 2050, or other suitable components that can communicate with the processor 2020.

In one embodiment, the variable function device 110a includes the processor 2020 for processing the data 3010 that has been transmitted by the computer 105a via link 115. The data 3010 may then be generated as an audio output 2040 via the output module 2050 and speaker 2045. Alternatively, the variable function device 110a may include an output module 2050 with a speaker(s) for generating the audio output 2040.

In all of the above-mentioned functions or operations, the audio output 2040 can be perceived by the second user 2080 for, e.g., entertainment purposes or alert/notification purposes.

In one embodiment, the computer 105a includes the streaming module (or/and software) 2051 which may be stored in, for example, the memory 2055. The streaming module 2051 permits the processor 125 to process the data 3010 in a conventional manner so that the data 3010 is streamed from the computer 105a to the variable function device 111a via link 115. Thus, in this embodiment, the computer 105a is functioning as a streaming audio server for streaming the data 3010 via link 115 to the variable function device 110a, while the variable function device 110a is functioning as a client for receiving the streamed data. Typically, the data 3010 is not stored by the variable function device 110a and is immediately generated as output signals 2040 by the variable function device 110a. Thus, the use of the computer 105a and the variable function device 110a enables a unique data streaming entertainment system or audio streaming entertainment system.

In an embodiment, the first user 2060 can personalize, preset, or preselect the particular data (e.g., data 2010, data collection 2087, broadcast data 3010, or other data) to stream from the computer 105 (specifically, computer 105a or 105b) to the variable function device 110a (via link 115) by use of a particular input command(s) 2053 via input device(s) 2075. The particular input command 2053 will program the processor 125 in selecting the particular data to stream via link 115 to the variable function device 110a. Alternatively or additionally, the second user 2080 can personalize, preset, or preselect the particular data (e.g., data 2010, data collection 2087, broadcast data 3010, or other data) to stream from the computer 105a (or 105b) to the variable function device 110a (via link 115) by use of a particular input command(s) 2085 via input module 2085.

Thus, in the embodiment shown in FIG. 20, the first user 2060 may use the computer 105a (105b) and hear audio signals (e.g., signals 2010, data collection 2087, broadcast data 3020, or other audio data) via speaker 2070. The first user 2060 may also view the visual output signals 2092 via screen 130 and control the computer 105a (or module 2094) via input device 2075. Additionally, the second user 2080 can hear audio signals (e.g., audio data 2010, data collection 2087, or broadcast data 3020) that are transmitted from the computer 105a (105b) to the variable function device 110a (via link 115) and generated from, for example, the speaker 2045 or output module 2050. The particular signal output 2091 (and/or signal output 2092) directed to the first user 2060 and the particular signal output 2040 directed to the second user 2080 may be distinct or different from each other, depending on the particular input commands 2053 to control the processor 125, and/or the particular input commands 2085 to control the processor 2020 and processor 125. Thus, the entertainment system 2100 can provide different forms of entertainment functions to different users 2060 and 2080.

In the embodiments illustrated in FIGS. 19 and 20, the particular audio signal 2091 generated from the computer 105a (or computer 105b) via speaker 2070 and the particular audio signal 2040 generated from the variable function device 110 via speaker 2045 (or output module 2050) may be pre-selected or personalized. For example, the input commands 2053 permits the first user 2060 to control the processor 125 to select any of the data 2010, data collection 2087, broadcast data 3010, or other data as the output for the audio output 2091. Similarly, the input commands 2085 permits the second user 2080 to control the processor 2020 (and processor 125) to select any of the data 2010, data collection 2087, broadcast data 3010, or other data as the output for the audio output 2040.

Current methods exist to separately stream two different audio signals to different destinations. By use of any of these current methods, for example, the data collection 2087 can be selected as audio output 2091 from the computer 105a (or computer 105b), while the data 2010 can be selected as audio output 2040 from the variable function device 110a.

In an embodiment of the invention, various methods may be used to stream an audio signal from the computer 105a (or from computer 105b) to the variable function device 110a via link 115. For example, a digital audio signal (e.g., data 2010 or data collection 2087) can be converted into analog signal on the computer 105a side prior to transmitting the signal across the link 115. A standard digital-to-analog (D/A) converter may be implemented in the I/O interface 120 or in the transceiver 2025 to convert the digital audio signal into an analog audio signal prior to transmitting the audio signal from the computer 105a to the variable function device 110a via link 115.

Alternatively, a digital audio signal (e.g., data 2010 or data collection 2087) can be transmitted in digital form from the computer 105a to the variable function device 110a via link 115. The transmitted digital audio signal is then converted into analog signal on the variable function device 110a side after transmitting the signal across the link 115. A standard digital-to-analog (D/A) converter may be implemented in the I/O interface 135 or in the transceiver 2026 in the variable function device 110a to convert the digital audio signal into an analog audio signal after transmitting the digital audio signal from the computer 105a to the variable function device 110a via link 115.

It is further noted that the processor 2020 in the variable function device 110a permits the following advantage. The processor 2020 (which may be a central processing unit or CPU) advantageously reduces the utilization of the processor 125 in the computer 105, since the processor 2020 can perform particular processor tasks or take over processor tasks that were previously performed by the computer processor 125. Such tasks include, for example, alerts (e.g., e-mail message or instant message alerts, Microsoft Outlook reminders, and/or entertainment information notifications such as a message “Channel 3 is now recording”), and/or other types of tasks.

Controlling a Computer Without Access to Input Device(s)

In the embodiments shown in FIG. 19 and FIG. 20, the second user 2080 can provide input command(s) 2085 to control particular functions in the computer 105 (e.g., computer 105a in FIG. 19 or computer 105b in FIG. 20). In an embodiment, the second user 2080 can press or select particular control buttons or selectors in the input module 2058, so that the processor 2020 can transmit a particular command signal 2095 (with the appropriate code or bits value) that will permit the processor 125 to execute a function desired by the second user 2085 such as, for example, the streaming of one of the data 2010, data collection 2087, or broadcast data 3010 (see FIG. 20) from the computer 105 to the variable function device 110a via link 115.

In another embodiment, the second user 2080 can use the remote control device 2059 to provide input command(s) 2085 to control particular functions in the computer 105. The second user 2080 can press or select particular control buttons or selectors in the remote control device 2059 to send input command(s) 2085 (with the appropriate code or bits value) so that the processor 2020 can transmit a particular command signal 2095 (with the appropriate code or bits value) to the input module 2058 that will permit the processor 125 to execute a function desired by the second user 2085 such as, for example, the streaming of one of the data 2010, data collection 2087, or broadcast data 3010 (see FIG. 20) from the computer 105 to the variable function device 110a via link 115. Other functions that can be permitted by a particular command signal(s) 2095 include, for example, permitting the processor 125 to adjust the brightness of the screen 130 output, to adjust the volume of the speaker 2070 output, to turn the computer 105 from an off-state to an on-state or from an on-state to an off-state, and/or other functions. As described below, a particular command signal(s) 2095 can also permit a method of organizing information (e.g., some information or alert outputs will be generated by the variable function device 110a instead of the computer 105). Thus, the second user 2080 does not need to use the input device(s) 2075 (such as a keyboard, mouse, touch-screen, other input devices), or input buttons on the computer 105 in order for the computer 105 to perform particular functions that are desired by the second user 2080. Additionally, the second user 2080 can advantageously access and permit various computer functionalities of the computer 105 without having to turn on the computer display device 130.

In one embodiment, the output module 2050 in the variable function device 110a includes a display screen, sound emitting element, motion actuation element, and/or other notification elements as similarly described above. Thus, the second user 2080 (or another user) can advantageously receive alert or feedback information 2096 (see FIG. 19) without having to turn on the computer screen 130 and without having to be located in the vicinity of the screen 130. The alert or feedback information 2096 may be, for example, a notification shown on a display screen, a sound or light signal, vibrations, or other output signals that can alert the second user 2080. Additionally, this feature permits the screen 130 to be in an off state while permitting the second user 2080 to still receive alert or feedback information. Since the screen 130 can be in an off state, heat generation and energy consumption by the screen 130 is advantageously reduced. Additionally, by permitting the output module 2096 to generate alert or notification information 2050 for the second user 2080 (or another user), the configuration of the screen 130 may be changed to a more compact or smaller size and/or to a less-energy consuming device.

Method of Organization of Information/Data

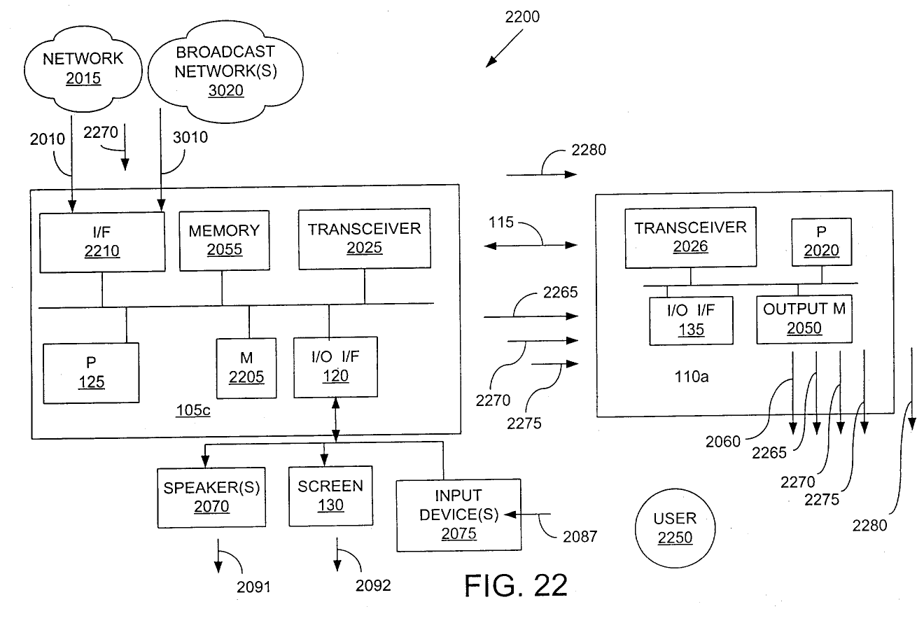

Referring now to FIG. 22, there is shown a block diagram of a notification system 2200, in accordance with an embodiment of the invention. In an embodiment, a computer 105c can communicate with the variable function device 110a to permit an improved method to organize information in a more convenient manner and/or to permit the display of information in an alternative convenient location. The computer 105c may be, in one embodiment, a home entertainment computer that is configured to provide home entertainment functions. However, the computer 105c may also be another type of computing device such as a personal computer, notebook computer, laptop, palmtop, server, micro-computer, mini-computer, workstation, or another suitable type of computing device. In an embodiment, the variable function device 110a is preferably a compact minimum size device that is portable, lightweight, and requires minimum “real estate” area.

In an embodiment, the computer 105c includes a network interface 2210 that can receive data (or signal(s)) 2010 from a communications network 2015 and/or receive data (or signal(s)) 3010 from a broadcast network 3020. The data 2010 and 3010, and networks 2015 and 3020, have been previously described above.

Additionally or alternatively, as similarly described above, a data collection 2087 (such as, for example, at least one compact disk, digital video disk (DVD), audio tape, digital tape, video tape or audio data from a video tape, and/or another audio source) may also be input into an input device 2075. Thus, the input device 2075 may include, for example, at least one of a compact disk player, DVD player, disk drive, audio tape player, digital tape player, camcorder, digital camera, video cassette recorder, or another device.

The data 2010 from the network 2015, data 3010 from broadcast network(s) 3020, data collection 2087, and/or other signals/data may also be output as audio output 2091 via speaker 2070 or/and as visual output 2092 (e.g., video, images, pictures) via screen 130. The speaker 2070 and screen 130 may be other types of suitable output devices for generating output signals that are perceivable to a user 2250. Of course, the speaker 2070 and screen 130 may be built in (or integrated with) the computer 105c. The audio output 2091 and visual output 2092 may be perceived by the user 2250 for, e.g., entertainment purposes.

In one embodiment, the computer 105c includes a data organization module 2205 which may be stored in, for example, the memory 2055. The data organization module 2205 permits the processor 125 to process the data 2010, data 3010, data collection 2087, or/and other data so that the processed data 2010, data 3010, data collection 2087 is generated as audio 2091 and/or visual output 2092, while information related to the data 2010, data 3010, data collection 2087 is generated as output 2260 via output module 2050 of the variable function device 110a. The output 2260 may be, for example, a visual output if the output module 2050 includes a display screen. The output 2260 may be, as another example, an audio output if the output module 2050 includes a sound emitting element (e.g., speaker(s)) and a sound card.

As an example, assume that a DVD movie or other file data is being shown via screen 130. The DVD file may be one of the data collections 2087 that is input via input device(s) 2075. Assume a PVR (personal video recorder) (or a VCR) starts recording TV program on a particular channel (e.g., channel 3). The PVR may be one of the input devices 2075 and the TV program may be one of the signals 3010 received from the broadcast network(s) 3020. The processor 125 can identify the particular TV program in a signal 3010 by, for example, reading an identifier information in the broadcast signal 3010. The data organization module 2205 permits the processor 125 to transmit an alert message 2265 via link 115 to the variable function device 110a, where the alert message 2265 identifies the particular TV program. The alert message 2265 is processed by the processor 2020 of the variable function device 110a and output via output module 2050. The alert message may be, for example, an audio and/or visual output, indicating that the PVR is now recording a particular channel (e.g., channel 3). Thus, the alert message 2265 is conveniently generated by the variable function device 110a and does not “clutter” the screen 130 of the computer 105c. The alert message 2265 may also, for example, include additional information such as the name of the TV program being recorded by the PVR, the programmed recording time, and/or other information.

As another example, assume that the computer 105c receives a transmitted message 2270 (e.g., e-mail or instant message) is received by the computer 105c. In response to the detection of the processor 125 of the transmitted message 2270, the data organization module 2205 permits the processor 125 to transmit an alert message 2270 via link 115 to the variable function device 110a. The alert message 2270 is processed by the processor 2020 of the variable function device 110a and output via output module 2050. The alert message 2270 will indicate that an e-mail message, instant message, or other message has been received by the computer 105c. Thus, the alert message 2270 is conveniently generated by the variable function device 110a and does not “clutter” the screen 130 of the computer 105c.

As another example, in response to a detection of the processor 125 of a particular event, the data organization module 2205 permits the processor 125 to transmit an alert message 2275 via link 115 to the variable function device 110a. The alert message 2275 is processed by the processor 2020 of the variable function device 110a and output via output module 2050. The alert message 2275 will indicate, for example, computer 105c system alerts such as high CPU utilization alerts, low battery warning, low memory capacity warning, error notification, and/or other types of alerts concerning the computer 105c. As another example, the data organization module 2205 permits that processor to transmit a notification or reminder signal 2280 via link 115 to the variable function device 110a, where the reminder signal 2280 may be, for example, a MICROSOFT OUTLOOK reminder or other types of reminders or notifications. Thus, the alert messages 2275 and 2280 are conveniently generated by the variable function device 110a and do not “clutter” the screen 130 of the computer 105c.

Multi-Room Embodiments

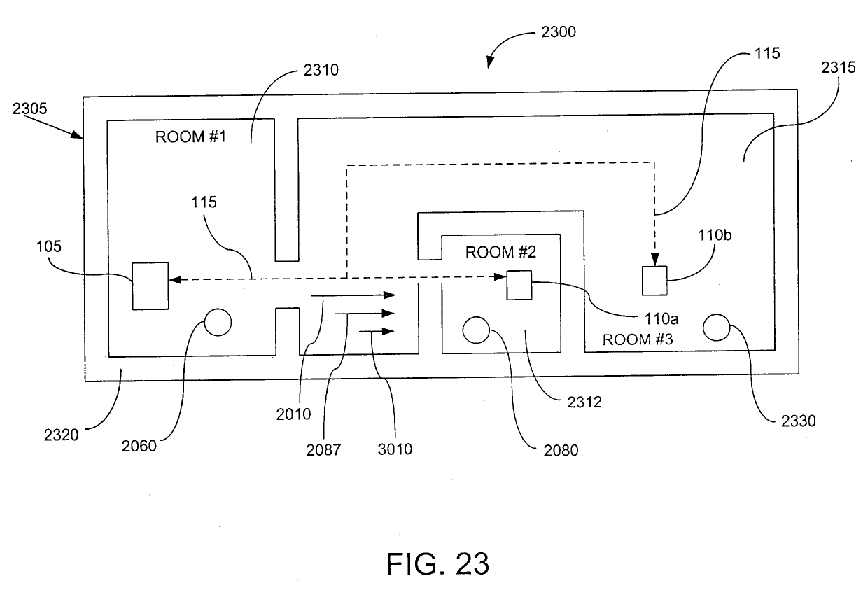

Referring now to FIG. 23, there is shown a block diagram of a multi-room entertainment system and/or notification system 2300 (hereinafter “multi-room system 2300), in accordance with an embodiment of the invention. The multi-room system 2300 may be implemented in a structure 2305 such as a residential dwelling or a business office. The computer 105 (e.g., computer 105a or computer 105b) may be in, for example, a first room 2310 (such a living room or family room). A variable function device 110a may be in a second room 2012 (e.g. a bedroom), while another variable function device 110b may be in a third room 2315 (e.g., a den or library). It is noted that in the example of FIG. 23, the variable function device 110b is similar to the variable function device 110a. Of course, the multi-room system 2300 can be implemented with only one of the variable function devices 105a and 105b or can be implemented with more than two variable function devices.

In the embodiment shown in FIG. 23, the computer 105 communicates with the variable function devices 105a and 105b via a wireless link 115 by use of suitable wireless communication techniques as described above. The wireless transmission protocol that is used by the multi-room system 2300 permits control signals to be transmitted through walls 2320 of the structure 2305 house. Additionally, a wireless transmission protocol that is used may be of long range capability so that a user can place either of the variable function devices 110a or 110b at farther distances from the location of the computer 105, and yet at the same time, permit communication between the computer 105 and the variable function devices 110a and 110b.

As an example, assume that the first user 2060 is using the first computer 105 in the first room 2310 for a task such as word-processing, computer games, DVD movie watching, or other tasks or entertainment purposes. The second person 2080 can use the variable function device 110a in the second room 2312 for other tasks, such as listening to an audio output that is streamed from the computer 105, as similarly described above. For example, the second person 2080 can use the variable function device 110a to listen to data 2010, data collection 2087, and/or broadcast data 3010 that is streamed from the computer 105 to the variable function device 110a. The second person 2080 can also use the variable function device 110a to receive notifications 2260, 2265, 2270, 2275, and/or 2280, as similarly described above. The second person 2080 may use the variable function device 110a for other entertainment tasks or other functions.

Similarly, the third person 2330 can use the variable function device 110b in the third room 2315 for a task such as word-processing, computer games, DVD movie watching, or other tasks or entertainment purposes. The third person 2330 can use the variable function device 110b in the third room 2315 for other tasks, such as listening to an audio output that is streamed from the computer 105 or receiving notifications from the computer 105, as similarly described above.

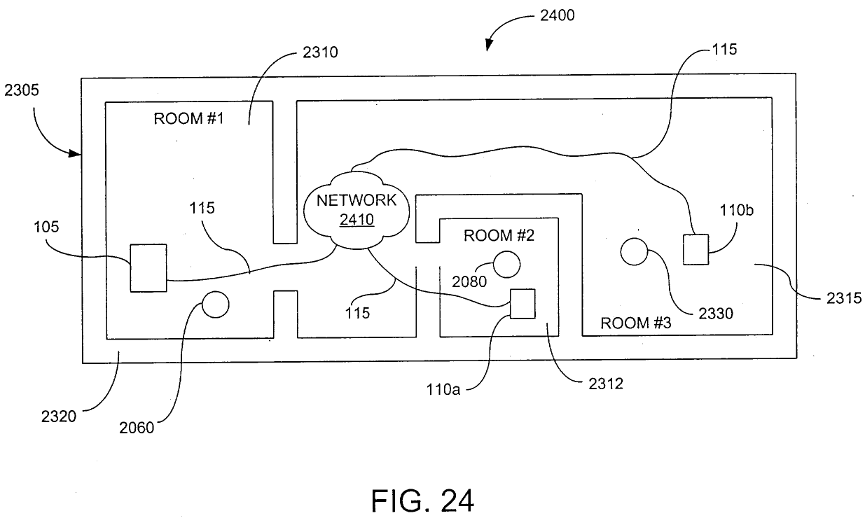

Referring now to FIG. 24, there is shown a block diagram of a multi-room entertainment system and/or notification system 2400 (hereinafter “multi-room system 2400), in accordance with an embodiment of the invention. The multi-room system 2400 may be implemented in a structure 2305 such as a residential dwelling or a business office, as similarly described above. The computer 105 and variable function device 110a (and/or variable function device 110b) may perform the same functions as described in FIG. 23. The number of variable function devices 110 may vary.

In the embodiment of FIG. 24, the variable function devices 110a and 110b can communicate with the computer 105 via a wired network 2410. The network 2410 may be, for example, a local area network or may be wirings within a portion of the structure 2305 (e.g., wirings through the walls 2320, ceiling, or floor). The computer 105 and variable function devices 110a and 110b may connect to the network 2410 via, for example, terminals in the walls 2320 or via other suitable interface components.

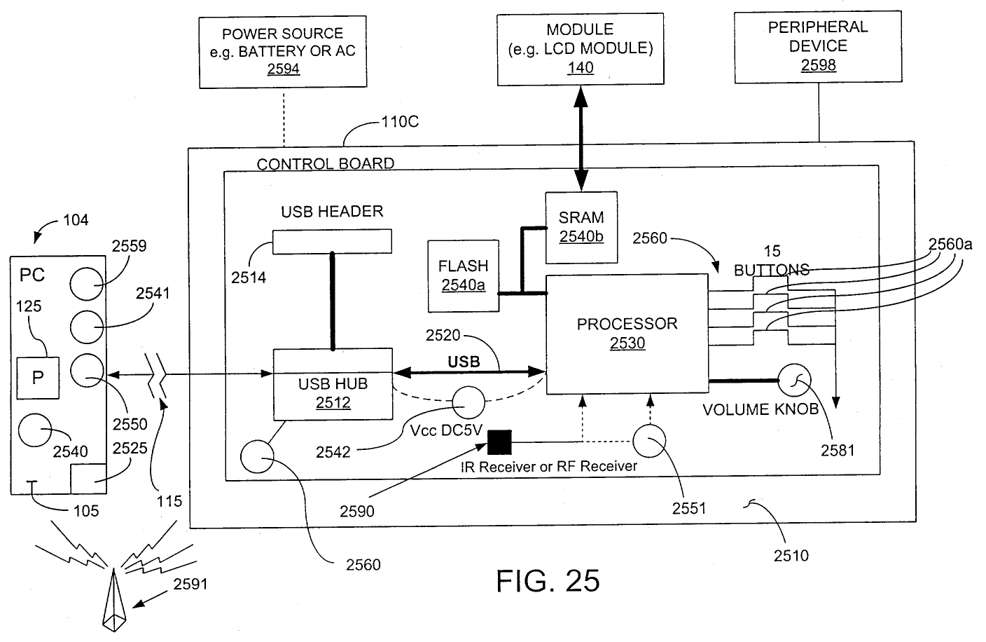

Referring now to FIG. 25 there is seen a function-producing device, generally illustrated as 104 for exemplary purposes. While the function-producing device 104 will be illustrated herein as the computer 105 having any associated processor (e.g., processor 125), it is to be understood that such illustration is not to limit embodiments of the present invention, and that the function-producing device 104 may be any device or assembly that is capable of producing a function for any purposes of the present invention. In one preferred embodiment, the function-producing device 104 may be any processor-containing device, such as a personal computer, a laptop, a notebook, a palmtop, a micro-computer, a mini-computer, a server, a workstation, or any of the like. In another preferred embodiment, the function-producing device 104 comprises an entertainment computer having a processor and including an audio and video generating system, such as an audio and video generating system for generating television images, stereo output, or any of the like. As indicated and more specifically, the function-producing device 104 may include the processor 125.

A function-producing device 104 (e.g., a personal computer, a lap top, a notebook, a server, or any of the like) having any suitable processor may possess at any particular time any one of the following operative state or modes: an “on” state or mode, a “sleep” (or standby) state or mode, or an “off” state or mode. For purposes of explaining the “on”, “sleep”, and “off” state or mode for the function-producing device 104 having any suitable processor (e.g., processor 125), a personal computer (“PC”) will be employed in the explanation. However, such use of personal computer is merely for exemplary purposes and is not to unduly limit the spirit and scope of embodiments of the present invention.

The “off” state or mode for a personal computer is the state or mode where the personal computer consumes minimum power, if any power at all. In the “on” state of mode for a personal computer, the personal computer is consuming maximum power. In the “sleep” (or standby) state or mode, the personal computer is consuming more power than in an “off” state or mode, but less power than in the “on” state or mode. The amount or quantity of power that a personal computer uses in any particular state or mode depends on the particular computer (e.g., a laptop vs. a personal computer, a notebook vs. a laptop, and/or other suitable devices) including its hardware and its associated function.

By way of example only, some personal computers in an “on” state or mode, consume at least than about 10 watts (joules per second), such as from about 10 watts to about 20 watts (e.g., more than about 10 watts but less than about 20 watts). Other personal computers in an “on” state or mode, consume at least about 15 watts, such as from about 15 watts to about 25 watts (e.g., more than about 15 watts but less than about 25 watts); or even at least about 20 watts (e.g., from about 20 watts to about 30 watts, such as more than about 20 watts but less than about 30 watts). Still other personal computers in an “on” state or mode consume at least about 25 watts (e.g., from about 25 watts to about 35 watts, such as more than about 25 watts but less than about 35 watts); or even at least about 30 watts (e.g., from about 30 watts to about 40 watts, such as more than about 30 watts but less than about 40 watts).

By further way of example only, some personal computers in a “sleep” (or standby) state or mode, consume less than at most about 25 watts (e.g., from about 15 watts to about 25 watts, such as less than about 25 watts but more than about 15 watts); or even less than at most about 20 watts (e.g., from about 10 watts to about 20 watts, such as less than about 20 watts but more than about 10 watts). Still other personal computers in a “sleep” (or standby) state or mode, consume less than at most about 10 watts (e.g., from about 2 watts to about 10 watts, such as less than about 10 watts but more than about 2 watts).

The quantity or amount of power consumed by a personal computer in the “off” state or mode also depends on the particular computer. Typically, in the “off” state or mode, a personal computer consumes less than at most about 5.0 watts, such as less than at most about 2 watts (e.g., from about 0.0 watts to about 2 watts); or even less than at most about 1.0 watt, (e.g., from about 0.05 watts to about 1.0 watt, or from about 0.1 watts to about 0.5 watts). The personal computer is typically connected to, for example, an AC source or battery source of power so that it is receiving, and typically consuming power even if the personal computer is in an “off” state or mode.

Presently, current personal computers need to be in an “on” state or mode, or in a standby or “sleep” state or mode, prior to performing a desired function or event, such as recording a television program on a channel (e.g., Channel 7), or prior to performing another desired function or event. By practice of embodiments of the present invention, the personal computer may now remain in an “off” state or mode, and then subsequently powered into an “on” state or mode by an appropriate signal being transmitted remotely at a desired time from a variable function device 110c, more specifically, for example, at a desired time from the variable function device 110c through the assistance of a remote control receiver 2590 and a processor 2530 of the variable function device 110c.

Thus, broadly by the practice of certain embodiments of the present invention, the operative state or mode of the personal computer may be changed at a desired time, such as from an “off” mode, or a “sleep” mode, to an “on” mode, or from an “on” mode to an “off” mode, or to a standby/“sleep” mode. Thus further, broadly by the practice of further embodiments of the present invention, the performance of a desired function or event by the personal computer may commence essentially simultaneously or subsequent with a change in operative mode of the personal computer. For example, the variable function device 110c may cause a signal to be transmitted to the personal computer. This signal may cause the personal computer to essentially immediately change the operative mode of the personal computer along with commencing performance at a desired function or event. The personal computer may include a timer (or delaying-action stage) identified as 2559 in FIG. 25, wherein the transmitted signal changes the operative mode of the personal computer and the timer (or delaying-action stage) 2559 causes the personal computer to delay the commencement of performance of a desired function or event for a desired period of time (e.g., 1 to 3 minutes) such that by way of example the personal computer may have sufficient time to perform one or more initial steps (e.g., download one or more programs needed to perform the function or event). Alternatively, the transmitted signal may initially change the operative mode and performance of a desired function or event after another signal is transmitted by the variable function device 110c through the assistance of a processor (e.g., processor 2530) and remote control receiver 2590.

Likewise, the termination of performance of a desired function or event by the personal computer may occur essentially simultaneously or prior to a change in operative mode. For example, variable function device 110c may cause a signal to be transmitted to the personal computer. This signal may cause the personal computer to essentially immediately change its operative mode along with terminating the performance of a desired function or event. As indicated, the personal computer may include a timer or delaying-action stage 2559. For this embodiment of the invention, the transmitted signal causes the personal computer to terminate the performing of a desired function or event, and the timer or delaying-action stage 2559 may cause the changed inoperative mode of the personal computer to be delayed for a desired period of time (e.g., 10 seconds to 2 minutes). Alternatively, the transmitted signal may initially terminate the personal computer from continuing to perform a desired function or event; and the change in operative mode of the personal computer could occur only after another signal is transmitted by the variable function device 110c through the assistance of a processor, such as processor 2530, and remote control receiver 2590. One or more additional desired functions or events may be conducted by the personal computer at any desired time, as well as a change of operative mode of the personal computer, by the timely transmission of appropriate signals from the variable function device 110c to the personal computer.

As indicated, when the personal computer is in an “on” state or mode, it can then perform a desired event, such as recording a television program or performing other events. After the desired event has been performed, the operative mode of the personal computer may then be changed, such as back to an “off” or “sleep” mode. Because the personal computer may remain “off”, or in a “sleep” state until the time the desired event occurs, the life of the semiconductor components in the personal computer is extended, particularly since heat-buildup and operation of the semiconductor components can now be reduced. Also, a personal computer in an “off” or “sleep” state or mode will produce less acoustic noise to a room (e.g., the fan in the personal computer will not need to run as often to cool down the personal computer, thus minimizing acoustic noise from the personal computer).

Continuing to refer to FIG. 25, the computer 105 is preferably coupled to the variable-function device 110c via the communication path 115. The computer 105 may include an output stage 2525, a receiver (or interface) 2540, and a converter 2541. The receiver 2540 may be any suitable receiver (and/or interface or tuner, e.g., AM/FM tuner) for receiving signals in order for functions to be performed in the computer 105. One of the features of certain embodiments of the present invention is that the computer 105 and the variable-function device 110c may provide a multi-user functionality, particularly when the computer 105 and the variable-function device 110c are located in different rooms of a dwelling or building. One person may use the computer 105 to, for example, play a game, use a word-processing program, listen to a radio broadcast or Internet radio broadcast, or watch a television broadcast or Internet broadcast. Another person may use the variable-function device 110c in a same room, or in a different room, to, by way of example only: (i) listen to an AM or FM radio program, or Internet radio broadcast or audio content (e.g., MP-3 data) from the Internet, as received by the receiver 2540 in the computer 105; (ii) listen to a music playlist (e.g., an MP-3 playlist, an audio playlist, or other types of audio data) stored in the computer 105; (iii) listen to a data collection (e.g., CD collection, tape collection, records, CD-ROM files, DVD files, and/or any of the like), as received by the computer 105; or (iv) listen to audio signals that are generated by the computer 105. Thus, the computer 105 may receive and output various audio signals from audio sources such as a music playlist, AM and/or FM programs, Internet radio programs, audio signals from TV programs, or any other audio sources. A user merely selects or programs (e.g., pre-set and/or personalized) which audio is to be received by the computer 105 (e.g., by the receiver 2540 of the computer 105), and which audio signal is to flow from the computer 105 to the variable-function device 110d for listening on or from the variable-function device 110c. Thus, by practice of embodiments of the present invention, a user can access and use various computer functionalities via the variable-function device 110c without having to turn on the computer display device and/or without having to use a computer keyboard and/or mouse. Furthermore, a user can use the variable-function device 110c in the same room, or in different rooms of a dwelling, to provide various computer functionalities, such as playing FM/AM radio programs, Internet radio programs, playing or accessing an audio playlist (e.g., MP-3 playlist), or playing or accessing a data collection (e.g., CD collection).

In an embodiment of the invention, the computer 105 could include sound cards to play sounds, an input/output (I/O) interface 120 (see FIG. 1) such as a USB interface, and a transceiver (or transmitter) 2550 that can be coupled to the I/O interface and be able to transmit audio signals (e.g., a stream of audio signals) to the variable-function device 110c via the communication link 115. For this embodiment of the present invention, the computer 105 would be acting as a streaming audio/music server, and the variable-function device 110c would be acting as a client. Speakers may be connected to the computer 105 to generate audio signals, or the computer 105 may have built-in speakers. The converter 2541 may be any suitable converter for converting an audio or similar signal, such as converting from a digital signal to an analog signal, or vice versa, for transmission purposes. In another embodiment, the converter 2541 is implemented in the I/O interface 120 or in the transceiver 2550.

The variable-function device 110c for the embodiment of the invention in FIG. 25 may have an I/O interface, such as a USB hub 2512. A transceiver (or receiver) 2560 may be coupled to the USB hub 2512 (or may be implemented in the USB hub 2512) to receive streaming audio signals from the computer 105. Thus, the variable-function device 110c may act as an agent for the computer 105, and would possess a sound card to permit playing of audio sounds that are transmitted from the computer 105. As was seen for the computer 105, the variable-function device 110c may have speakers coupled thereto, or built in the variable-function device 110c, to generate audio output signals. The streaming audio signal (e.g., from an MP-3 playlist or a audio files in a compact disc (CD)) from the computer 105 to the variable-function device 110c may be converted by converter 2541 from a digital audio signal into an analog audio signal. Alternatively, the streaming audio signal from the computer 105 to the variable-function device 110c may be transmitted in digital form to the variable-function device 110c, and then converted by converter 2542 in the variable-function device 110c into analog form. The converter 2542 may be any suitable converter for converting an audio or similar signal into any desired format, such as converting from a digital signal to an analog signal, or vice versa, for audio signal processing purposes.

The variable-function device 110c for the embodiment of the invention in FIG. 25 also includes a control board 2510 for supporting the USB hub 2512. Additionally, an optional USB header 2514 may be coupled to the USB hub 2512. A communication link 2520 (e.g., a USB) couples the USB hub 2512 to the processor 2530 which may be operatively connected to at least one module 140 (e.g., an LCD module). As best shown in the example of FIG. 25, the processor 2530 preferably includes or has access to suitable memory 2540 (e.g., flash memory 2540a, SRAM memory 2540b, and/or other suitable types of memory elements), and an input stage 2560 for receiving a suitable input (e.g., input 145 in FIG. 1) to enable the processor 2530 to execute a function(s). Input stage 2560 may include, for example, a plurality of buttons 2560a for manual manipulation to provide appropriate input signals for control purposes.

An audio control device 2581 (e.g., a volume knob) may be coupled to processor 2530 for controlling the audio output of any device (e.g., a speaker or other device) coupled to the variable function device 110c or any device coupled to the computer 105. Also coupled to the processor 2530 may be a remote control receiver 2590 for receiving a control signal to permit signaling of the processor 2530 so that the processor 2530 can permit the execution of a desired function or event as performed by the variable function device 110c (or by the variable function device 110c and computer 105). Remote control receiver 2590 may be any suitable remote control receiver which is capable of receiving a signal from any suitable remote control transmitter 2591.

A remote control function generally is the control of an operation from a distance. This function typically involves a link, usually electrical, or a wireless link between the remote control device and the apparatus to be operated. Thus, a remote control function may be over direct wire path or wireless path. Various types of interconnecting channels for remote control function include infrared (IR), radio frequency (RF), carrier-current, microwave, supervisory control, or mechanical components. In an embodiment of the invention, the remote control receiver 2590 comprises an infrared (IR) receiver which receives an infrared signal from transmitter 2591.

As further best shown in FIG. 25, the variable function device 110c may communicate with any suitable power source 2594 (e.g., AC source or a battery) for receiving operative power and with any suitable device 2598 (e.g., a recorder, speaker and/or other device(s)) which is to be controlled by the variable function device 110c or which is communicatively linked to the variable-function device 110c.

The remote control receiver 2590 may appropriately receive transmitted signals from transmitter 2591 to “wake up” the function-producing device 104 (e.g., computer 105 such as any suitable PC) from a full power down mode (e.g., an “off” state or mode), in order to perform pre-scheduled tasks, such as recording a television program. In another embodiment of the invention, the remote control receiver 2590 of the variable function device 110d may receive a signal from transmitter 2591 to “wake up” the function-producing device 104 from a standby or “sleep” state or mode.

As shown in FIG. 25, a suitable clock 2551 (e.g., an alarm clock) may be provided for sending an appropriate signal to the processor 2530, which in turn causes a change-of-mode or function-performing signal to be transmitted to the function-providing device 104 (e.g., the computer 105). The remote control receiver 2590 may receive clock-setting signals from transmitter 2591 to set the clock 2551 for performing a task or function, and for terminating the performance of the task or function. In an embodiment of the invention, the remote control receiver 2590 singly, or in combination with clock 2551, may “wakeup” the device 104 at a desired time to in order for the device 104 to perform a desired function and to terminate the performance of the desired function at a desired time, and if desired to change the operative mode of the device 104, such as from an “on” mode to an “off” mode. As indicated, the operative mode may be changed simultaneously with terminating of the performance of the desired function, or subsequent to terminating the performance of the desired function.

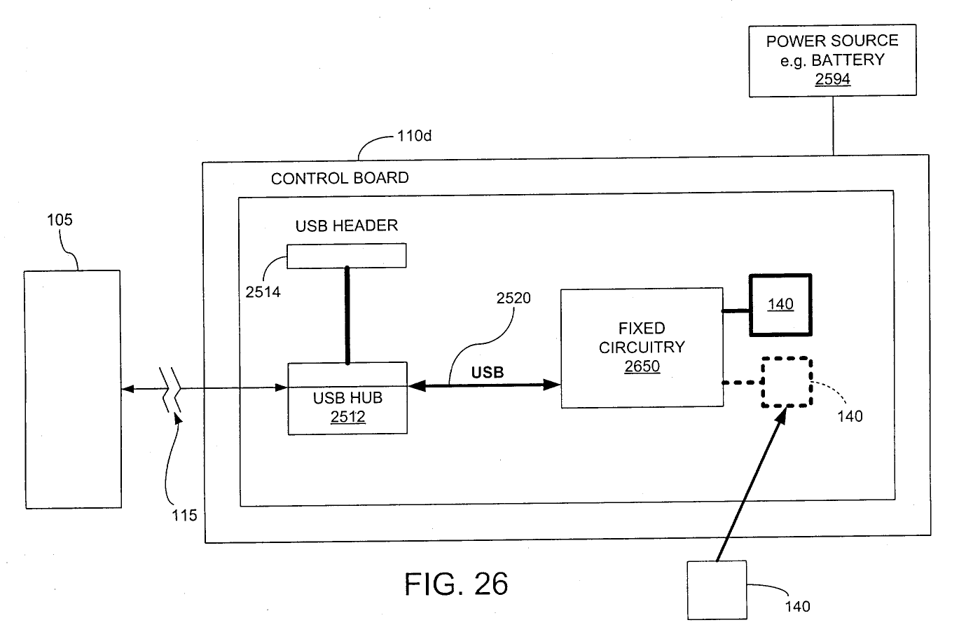

Referring now to FIG. 26, there is seen the variable function device 110d having a fixed (or integrated) circuitry 2650 to which one or more module(s) 140 may be coupled. The fixed circuitry is typically a standard circuit or electrical interface that permits the electrical components in the variable function device 110d to function for their designed purposes.

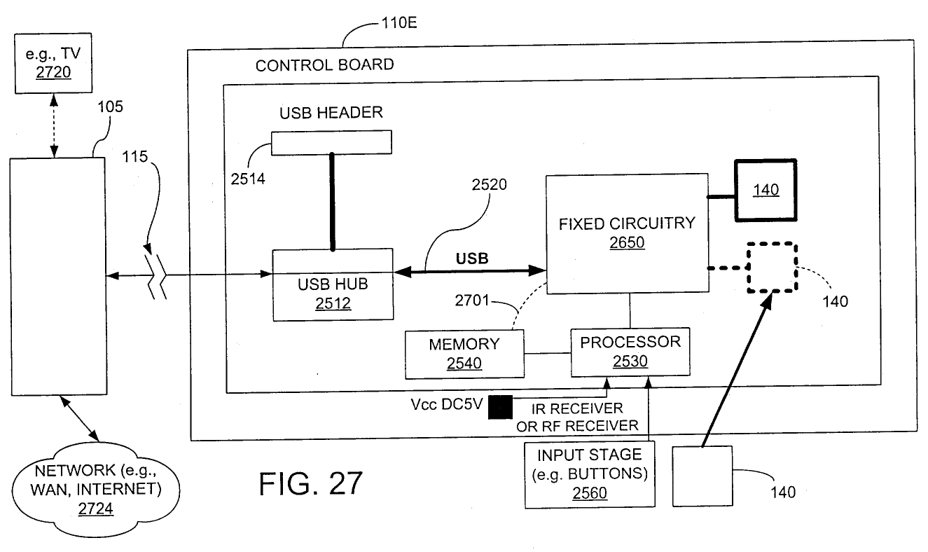

As also shown by a variable function device 110e in FIG. 27, the processor 2530 (with or without having memory 2540 of FIG. 25) may be coupled to the fixed circuitry 2650. Alternatively, the memory 2540 may be coupled directly to the fixed circuitry 2650 (as illustrated by dashed line 2701). The remote control receiver 2590 may be conveniently coupled to processor 2530 or may be directly coupled to the fixed circuitry 2650. By coupling one module 140 to the fixed circuitry 2650, the variable function device 110e may produce a desired function. By coupling a second module 140 to the fixed circuitry 2650, the variable function device 110e may produce an additional desired function. If one module 140 is replaced by a second module 140, or with two or more modules 140, a function produced by the variable function device 110f changes. Thus, additional functions may be generated by adding and coupling to the fixed circuitry 2650 more modules 140, and one or more functions produced by the variable function device 110e may be changed by replacing a first module 140 with a second module 140, or with two or more modules 140.

As best shown in FIG. 27, one (or more) device(s) 2720 and/or network(s) 2724 may be operatively engaged to the computer 105. Device 2720, by way of example only, may be an audio and visual producing device, such as a television, stereo device, and/or other suitable device; and the network(s) 2724 may be a wide area network (WAN) such as the Internet, another type of public WAN, a private WAN, a local area network (LAN), a broadcast network such as a radio or television network, a telecommunication network or telephone network, a satellite network, and/or any of the like. The computer 105 may store and/or download into memory or storage any desired function or event from the device 2720 (e.g., an entertainment function) or network 2724 prior to recording the function or event, or prior to generating the function or event via computer 105 or via the variable function device 110e. It is to be understood that the particular function of the variable function device 110e may be assigned at any suitable time, such at program run time.

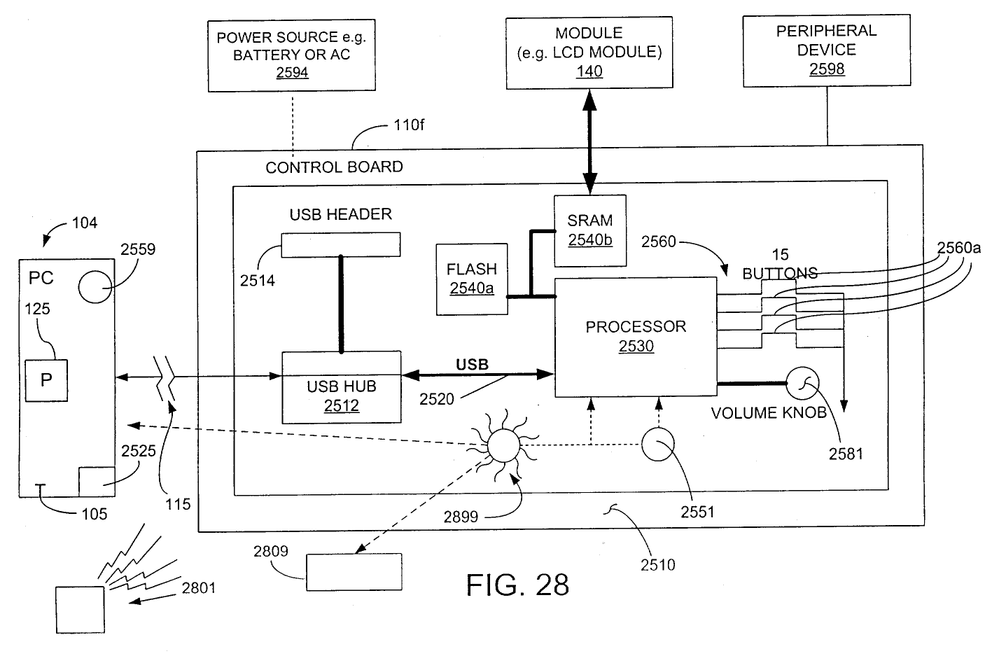

Referring now to FIG. 28, there is seen a block diagram of another embodiment of the invention including a variable function device 110f coupled to the function producing device 104 such as the computer 105. The variable function device 110f includes or is coupled to an infrared (IR) blaster, generally illustrated as 2899. As known to those skilled in the art, IR blasters mimic infrared signal that are sent from remote control devices, such as a remote control device 2801. The IR blaster 2899 will receive the signal from the remote control device 2801 and will subsequently transmit an infrared signal, preferably a coded infrared signal mimicking the command signal of remote control device 2801. In the embodiment of the invention in FIG. 28, the IR blaster 2899 in the variable function device 110f will send an infrared command signal to the processor 2530, and/or to another device, such as device 2809 or computer 105, to ultimately cause an event to be performed. For example, in response to an infrared command signal from the IR blaster 2899, the processor 2530 will transmit a command signal vial line 115 to the computer 105 to permit an event to be performed by the computer 105. As another example, in response to an infrared command signal from the IR blaster 2899, the device 2809 will perform by a particular event(s). In the embodiments in FIG. 28, the infrared command signal is received and decoded by the target device (e.g., computer 105 or device 2809) so that the target device performs an event, such as turning on the target device, or turning on and playing music by the target device, or playing music by the target device if the target device is already on.

As indicated, the remote control assembly (e.g., the combination of transmitter 2591 and remote control receiver 2590, or IR blaster 2899 and device 2801) may be used to control other devices, such as the variable function device 110, computer 105, and/or device 2809. The remote control receiver 2590 receives a transmitted coded signal which is subsequently decoded by, for example, the processor 2530 or processor 125, or by any other suitable decoder. Similarly, in response to a transmitted coded signal, the IR blaster 2899 generates an output which is subsequently decoded by, for example, the processor 2530 or processor 125, or by any other suitable decoder. In the event that the target device is the computer 105, the computer 105 can perform an action or event which would correspond to a button on the remote control device 2801 or transmitter 2591; and/or send command signals to any other device to perform the action/event. It is noted that the transmitter 2591 in FIG. 25 may be implemented in, for example, a remote control device. By way of example only: a remote control button #1 could represent, and cause when depressed, the implementation of action/event (e.g., show TV Channel 12 program); a remote control button #2 could represent, and cause when depressed, the implementation of action/event (e.g., play DVD movie); and a remote control button #3 could represent, and cause when depressed, the implementation of action/event (e.g., play a music file such as an MP-3 music file). Thus, in an embodiment, the microprocessor 125 of the computer 105 receives and decodes a signal from a remote control assembly, and subsequently matches the signal with a particular function or event from a set of functions or events (e.g., a “look up” table).

It is to be understood that suitable software in the computer 105 may be programmed to change a relationship or link between a particular remote control button and a corresponding action/event. In order to change a link/relationship, a “look up” table (e.g., a set of possible functions or events) in memory of the computer 105 is changed, such that a particular button on the remote control device represents a new action/event. Also consumers may obtain, e.g., via Internet or via a manufacturer, a coding list of action/events for storage in computer memory and for execution by the processor-125 to permit an action/event to be executed by a suitable consumer electronic device.

Broadly, one or more of the modules (e.g., module 140) for embodiments of the present invention may be, by way of example only and not by way of limitation, any collection of one or more of circuitry, software, firmware, and hardware (e.g., display mechanisms, components, or any other suitable elements, and/or any of the line), all designed to perform a desired operation. More specifically, any of the modules for embodiments of the present invention may be any suitable module which is capable of functioning for the purpose of embodiments of the present invention. The module may include, by way of example only and not by way of limitation, a board or board set that provides mechanical mounting and protection for associated electric components, thermal transfer of heat away from the components to an external heat sink, and electrical and fiber optic connections. The module may include, by way of example only and not by way of limitation, one or more nodes that share a physical interface to a scalable coherent interface (SCI) which functionally behaves as a bus and may further include, for example, a collection of point-to-point unidirectional boards with backplane-mating connectors. The module may also be, by way of example only and not by way of limitation, an electronic circuit assembly that connects to one or more slots on a backplane assembly, and may be removable from the backplane assembly via connectors.

One or more embodiments of the present invention may permit many functions to be consolidated into, for example, one small, compact, tethered device or/and portable device. In one embodiment, the variable-function device (shown herein as, for example, variable function devices 110 and 110a-110f) is compact in nature and requires minimal surface area and/or space. Thus, an embodiment of the variable-function device 110 may be conveniently placed on a user's desk, table, furniture, workspace, home counter, and/or other areas. Thus, in an embodiment, the variable-function device 110 may be optimally located in a position within each user's environment. An embodiment of the invention may permit functions to be removed from a computer (e.g., a PC) or other processing device in order to simplify the base system and/or components of the computer or other processing device. Additionally, an embodiment of the invention may permit the computer and variable-function device 110 to have, for example, separate development schedules to reduce risks, and/or separate definitions to enable changes and/or multiple offering of functions in the variable-function device 110. Additionally, since an embodiment of the invention permits functions to be removed from a computer or other processing device, the modified-function computer or other processing device can now be easier and cheaper to support in the field as compared to current computers or other current processing devices. Additionally, an embodiment of the invention may provide more functions to the user without burdening or increasing complexity to the main system in the computer or other processing device. As a result, the computer (or other processing device) may become more reliable, and the cost of service may be reduced for the computer (or other processing device).

Additionally, one or more embodiments of the present invention may permit a user to be notified or receive feedback on events without requiring the computer display (or other processing device display) to be visible to the user. An embodiment of the invention may also offer to the user more feedback on the state of the user's computer environment. An embodiment of the invention may also reduce the clutter in the screen of the computer (or other processing device) by offering an alternative display location for selected functions.

One or more embodiments of the present invention may be advantageously utilized with any appliance (or device) that is adapted to communicate with a communication link and/or perform other processing functions, and thus is not limited to the variable-function devices as described in the foregoing embodiments.

It is to be understood that the processor for any embodiments of the present invention may be any suitable integrated circuit that may or preferably contain the logic elements for manipulating data and for making decisions. The processor may include, by way of example only and not by way of limitation, an interpreter, a computer and run-time system, or other mechanisms together with an associated host computing machine and operating systems. The processor may also include or be provided with any suitable software, and may be implemented in a microprocessor, a micro-computer, a mini-computer, a workstation, a server, a personal computer, a notebook or laptop computer, or other suitable computing devices.

The various engines or modules discussed herein may also be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching. Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus for providing entertainment functions to multiple users, the apparatus comprising:
a computer configured to receive audio data, and process the audio data for subsequent transmission as a streaming audio data, the computer configured to provide an entertainment function to a first user; and
a variable function device configured to receive the streaming audio data from the computer and output the streaming audio data as an entertainment function for a second user.

2. The apparatus of claim 1, wherein the computer is coupled to the variable function device by a wireless link.

3. The apparatus of claim 1, wherein the computer is coupled to the variable function device by a wired link.

4. The apparatus of claim 1, wherein the computer comprises an entertainment computer.

5. The apparatus of claim 1, wherein the audio data is obtained from a communication network.

6. The apparatus of claim 1, wherein the audio data is obtained from a broadcast network.

7. The apparatus of claim 1, wherein the audio data is obtained from a data collection.

8. The apparatus of claim 1, wherein audio data is streamed as a digital signal from the computer to the variable function device and converted into an analog signal by the variable function device.

9. The apparatus of claim 1, wherein audio data is converted into an analog signal streamed by the computer and streamed as an analog signal to the variable function device.

10. The apparatus of claim 1, wherein the audio data is stored as a playlist prior to output as streaming audio data to the variable function device.

11. The apparatus of claim 1, wherein the computer comprises a processor configured to process the audio data.

12. The apparatus of claim 1, wherein the variable function device comprises a processor configured to process the streamed audio data.

13. The apparatus of claim 1, wherein the first user can preselect a particular audio data for output by the computer.

14. The apparatus of claim 1, wherein the second user can preselect a particular audio data to be streamed to the variable function device and to be output by the variable function device.

15. The apparatus of claim 14, wherein the second user can preselect a particular audio data to be streamed to the variable function device by providing an input command to the variable function device.

16. The apparatus of claim 1, wherein the computer outputs a particular audio data and streams another particular audio data to the variable function device.

17. The apparatus of claim 1, wherein the second user can permit a particular function in the computer, including the streaming of a particular audio data to the variable function device, by providing an input command to the variable function device.

18. The apparatus of claim 15, wherein the second user may provide the input command by use of a remote control device.

19. A method for providing entertainment functions to multiple users, the method comprising:
receiving, by a computer, audio data, and processing, by the computer, the audio data for subsequent transmission as a streaming audio data;
transmitting the audio data as a streaming audio data; and
receiving, by a variable function device, the streaming audio data, and generating, by the variable function device, the streaming audio data as an entertainment function.

20. The method of claim 19, wherein the computer is coupled to the variable function device by a wireless link.

21. The method of claim 19, wherein the computer is coupled to the variable function device by a wired link.

22. The method of claim 19, wherein the computer comprises an entertainment computer.

23. The method of claim 19, wherein the audio data is obtained from a communication network.

24. The method of claim 19, wherein the audio data is obtained from a broadcast network.

25. The method of claim 19, wherein the audio data is obtained from a data collection.

26. The method of claim 19, further comprising:
prior to transmitting the audio data, storing the audio data as a playlist.

27. The method of claim 19, further comprising:
selecting, by a first user, a particular audio data for output by the computer.

28. The method of claim 19, further comprising:
selecting, by a second user, a particular audio data for transmission to the variable function device.

29. The method of claim 28, wherein the second user can preselect a particular audio data for transmission to the variable function device by providing an input command to the variable function device.

30. The method of claim 19, further comprising:
permitting, by a second user, a particular function in the computer, including the streaming of a particular audio data to the variable function device, by providing an input command to the variable function device.

31. An apparatus for organizing information, the apparatus comprising:
a computer configured to receive data, and generate information associated with the received data or information associated with a functionality of the computer; and
a variable function device configured to receive the generated information and provide the generated information to a user.

32. The apparatus of claim 31, wherein the computer and the variable function device are connected by a wireless link.

33. The apparatus of claim 31, wherein the computer and the variable function device are connected by a wired link.

34. The apparatus of claim 31, wherein the generated information includes one of an alert notification related to the received data, an identification information related to content of the received data, an alert notification related to a function of the computer, and a programmed notification provided by the user.

35. A method for organizing information, the method comprising:
receiving, by a computer, data, and generating, by the computer, information associated with the received data or information associated with a functionality of the computer; and
receiving, by a variable function device, the generated information, and providing, by the variable function device, the generated information to a user.

36. The method of claim 35, wherein the computer and the variable function device are connected by a wireless link.

37. The method of claim 35, wherein the computer and the variable function device are connected by a wired link.

38. The method of claim 35, wherein the generated information includes one of an alert notification related to the received data, an identification information related to content of the received data, an alert notification related to a function of the computer, and a programmed notification provided by the user.

39. An apparatus for providing multi-room entertainment functions, the apparatus comprising:
a computer configured to receive audio data, and process the audio data for subsequent transmission as a streaming audio data, the computer configured to provide an entertainment function in a first room; and
a variable function device configured to receive the streaming audio data from the computer and output the streaming audio data as an entertainment function in a second room.

40. The apparatus of claim 39, wherein the computer is coupled to the variable function device by a wireless link.

41. The apparatus of claim 39, wherein the computer is coupled to the variable function device by a wired link.

42. The apparatus of claim 39, wherein the computer comprises an entertainment computer.

43. The apparatus of claim 39, wherein the audio data is obtained from a communication network.

44. The apparatus of claim 39, wherein the audio data is obtained from a broadcast network.

45. The apparatus of claim 39, wherein the audio data is obtained from a data collection.

46. The apparatus of claim 39, wherein audio data is streamed as a digital signal from the computer to the variable function device and converted into an analog signal by the variable function device.

47. The apparatus of claim 39, wherein audio data is converted into an analog signal streamed by the computer and streamed as an analog signal to the variable function device.

48. The apparatus of claim 39, wherein the audio data is stored as a playlist prior to output as streaming audio data to the variable function device.

49. The apparatus of claim 48, wherein the computer comprises a processor configured to process the audio data.

50. The apparatus of claim 39, wherein the variable function device comprises a processor configured to process the streamed audio data.

51. The apparatus of claim 39, wherein a first user can preselect a particular audio data for output by the computer.

52. The apparatus of claim 39, wherein a second user can preselect a particular audio data to be streamed to the variable function device and to be output by the variable function device.

53. The apparatus of claim 52, wherein the second user can preselect a particular audio data to be streamed to the variable function device by providing an input command to the variable function device.

54. The apparatus of claim 39, wherein the computer outputs a particular audio data and streams another particular audio data to the variable function device.

55. The apparatus of claim 39, wherein a second user can permit a particular function in the computer, including the streaming of a particular audio data to the variable function device, by providing an input command to the variable function device.

56. The apparatus of claim 55, wherein the second user may provide the input command by use of a remote control device.

57. The apparatus of claim 39, wherein the computer configured to receive data, and generate information associated with the received data or information associated with a functionality of the computer, and the variable function device configured to receive the generated information and provide the generated information in the second room.

58. A method for providing multi-room entertainment functions, the method comprising:
receiving, by a computer in a first room, audio data, and processing, by the computer, the audio data for subsequent transmission as a streaming audio data;
transmitting the audio data as a streaming audio data; and
receiving, by a variable function device in a second room, the streaming audio data, and generating, by the variable function device, the streaming audio data as an entertainment function.

59. The method of claim 58, wherein the computer is coupled to the variable function device by a wireless link.

60. The method of claim 58, wherein the computer is coupled to the variable function device by a wired link.

61. The method of claim 58, wherein the computer comprises an entertainment computer.

62. The method of claim 58, wherein the audio data is obtained from a communication network.

63. The method of claim 58, wherein the audio data is obtained from a broadcast network.

64. The method of claim 58, wherein the audio data is obtained from a data collection.

65. The method of claim 58, further comprising:
prior to transmitting the audio data, storing the audio data as a playlist.

66. The method of claim 58, further comprising:
selecting, by a first user, a particular audio data for output by the computer.

67. The method of claim 58, further comprising:
selecting, by a second user, a particular audio data for transmission to the variable function device.

68. The method of claim 58, wherein the second user can preselect a particular audio data for transmission to the variable function device by providing an input command to the variable function device.

69. The method of claim 58, further comprising:
permitting, by a second user, a particular function in the computer, including the streaming of a particular audio data to the variable function device, by providing an input command to the variable function device.

70. The method of claim 58, further comprising:
receiving, by the computer data, and generating, by the computer, information associated with the received data or information associated with a functionality of the computer; and
receiving, by the variable function device, the generated information, and providing, by the variable function device, the generated information in the second room.

71. A method for providing multi-user entertainment comprising:
providing a variable-function device communicatively coupled to a function-producing device comprising a processor;
duplicating a function from the function-producing device;
providing the duplicated function in the variable-function device;
accessing the function from the function-producing device; and
accessing the duplicated function from the variable-function device.
